(19) United States
(12) Patent Application Publication
(10) Pub. No.: US 2026/0332533 A1
(43) Pub. Date: Oct. 22, 2026

(54) DECOUPLING OF TELEMETRY DATA PRODUCTION FROM NETWORK TRANSMISSION DURING NETWORK CONGESTION IN A PROCESSOR-BASED SYSTEM

(71) Applicant: Microsoft Technology Licensing, LLC, Redmond, WA (US)

(72) Inventors: Serena BADRAN-LOUCA, Raleigh, NC (US); Richard Gerard HOFMANN, Cary, NC (US); Jeremiah FRANKE, Tigard, OR (US); Larry Alan WOODRUM, Austin, TX (US); Aayush PATHAK, Bellevue, WA (US); Sheena GOEL, Austin, TX (US)

(21) Appl. No.: 19/186,332

(22) Filed: Apr. 22, 2025

(51) Int. Cl. H04L 47/26; H04L 43/022; H04L 47/10; H04L 47/129

(52) U.S. Cl. CPC H04L 47/26; H04L 43/022; H04L 47/129; H04L 47/23

(57) ABSTRACT

Decoupling of telemetry data production from network transmission during network congestion in a processor-based system is disclosed. The processor-based system includes processor cores (“cores”) that can each execute computer program instructions to perform tasks. To avoid the issue of analyzing telemetry data relating to the cores collected for a given epoch that may include missing and thus incomplete telemetry data, such as due to network congestion, a telemetry data system in the processor-based system is configured to track timing of receipt of telemetry data packets. If any telemetry data packets have not been timely received for an expected epoch, an epoch status for such epoch is recorded as having incomplete telemetry data for such epoch. This ensures complete telemetry data received for a given epoch is analyzed to more accurately control performance in the processor-based system.

### FIELD OF THE DISCLOSURE

The technology of the disclosure relates generally to communication of telemetry data (e.g., temperature, voltage, current consumption, performance data) obtained within a processor-based system for performance analysis and control of the processor-based system.

### BACKGROUND

Processing units (PUs) perform computational tasks for a wide variety of applications. A PU includes a processor that includes one or more processor cores (also referred to as just “cores”). The processor cores are configured to execute software/firmware instructions (“instructions”) to perform tasks. The PU may be included in an integrated circuit (IC) as a system-on-a-chip (SoC) that combines multiple PUs with other support computing components (e.g., memory, input/output ports, etc.). An SoC may integrate several different PUs (e.g., a central processing unit (CPU), a graphic processing unit (GPU), a neural processing unit (NPU)), memory controllers, and other specialized modules (like artificial intelligence (AI) or multimedia accelerators) on one or more dies, creating compact and powerful PUs. This can increase efficiency, reduce power consumption, and enable faster data transfer across such components. Mesh networks are also provided in an SoC to allow for seamless data communication among processor cores and different computing devices, thus reducing latency and increasing bandwidth. The mesh network includes a plurality of routing circuits (also referred to as “nodes” or “routers”) that are each connected to several routing circuits in a grid-like pattern, enabling direct communication between components without needing to go through a central bus or hub, thereby optimizing data transfer. The routers receive data in the form of data packets from processor cores (or other peripheral circuitry) and then transfer such data packets to other processor cores or peripheral circuitry in the mesh network.

Telemetry data plays a critical role in managing and controlling an SoC's performance, heat dissipation, power consumption, and fault tolerance. An SoC and its processor cores can be configured to continuously collect telemetry data collected from sensors embedded within the chip, monitor parameters like temperature, voltage, current consumption, workload distribution, and/or other hardware events like performance across cores. This data can then be communicated as data packets over the SoC's internal mesh network to a centralized or distributed controller, which can dynamically adjust parameters for the SoC and/or the processor cores, such as voltage and clock speed, to maintain optimal performance in the SoC. Through network communication protocols, telemetry data can also be stored to be accessed by monitoring systems that can provide access to the telemetry data to gain insights into the SoC's health and performance in real time. This closed-loop communication of telemetry data enhances system stability and improves energy efficiency, making SoCs ideal for complex applications in power-sensitive environments.

In order for telemetry data to be effectively used to control SoC performance, the internal mesh network needs to be able to transmit data packets in an efficient manner. Network congestion can occur in the mesh network when their routers reach their data-handling capacity. In this situation, the mesh network may not be able to receive and route new data packets until the existing in-flight data packets are transferred out of the mesh network and network congestion is resolved. Thus, at times during network congestion, data packets may be dropped by their originating source, thereby leading to data throughput inefficiency and latency in the ability of the SoC performance to be monitored and controlled efficiently.

### SUMMARY

Exemplary aspects disclosed herein include decoupling of telemetry data production from network transmission during network congestion in a processor-based system. The processor-based system includes a processing unit (PU) (e.g., a central processing unit (CPU)) that includes one or more processor cores (“cores”) that can each execute computer program instructions to perform tasks. The processor-based system may be provided as a system-on-a-chip (SoC) as an example, wherein the processor(s) is incorporated into a single integrated circuit (IC) chip along with other supporting computing components (e.g., memory, communications buses, input/output ports, etc.). The processor-based system includes an internal communication network (e.g., a fabric mesh network) that interfaces the cores with supporting computing components to allow the cores to make requests to the supporting computing components as part of carrying out computing tasks, and vice versa (e.g., snoop requests). The processor-based system is also configured to collect telemetry data that represent or affect performance characteristics of the cores (e.g., temperature, voltage, consumed current, etc.). Telemetry data circuits, which each may be associated with a given core or as part of the core, can be provided and configured to collect telemetry data for its associated core and provide such telemetry data to a telemetry producer circuit associated with the core. The telemetry producer circuits associated with the cores are each configured to communicate the received telemetry data for its associated core as telemetry data packets over the internal communication network. The internal communication network is configured to route the telemetry data packets to a telemetry consumer circuit in the processor-based system that includes or interfaces with a telemetry memory that may be a shared access memory (e.g., a random access memory (RAM) buffer). The telemetry consumer circuit is configured to store the telemetry data in the telemetry memory such that the telemetry data can independently be accessed from the telemetry memory to be analyzed by a separate processor(s) to determine a performance state of a core and/or the overall processor-based system and/or if a performance parameter(s) of a core and/or the overall processor-based system should be changed to control their performance. For example, telemetry data regarding power consumption of a core(s) may be used to manage a power state for a core(s) (e.g., idle, normal power state, high power state) and/or the overall processor-based system to be within desired power limits. The telemetry data may also be used to control a performance state of the core(s) (e.g., supply voltage and frequency) to improve system performance and/or to manage power consumption of a core(s).

In exemplary aspects, telemetry data circuits associated with the cores are each configured to periodically collect telemetry data associated with their cores. In this manner, the telemetry data circuits are controlled to collect telemetry data relating to the cores in an ongoing, periodic fashion so that telemetry data associated with the cores is available to be analyzed for a given time period. This also allows determination of the state and performance of a plurality of the cores in the processor-based system based on their telemetry data collected in the same time period. For example, it may be desired to understand and analyze telemetry data associated with multiple cores that was collected in the same time period to have an understanding of the state of each of those cores for that time period. The collected telemetry data is provided to respective telemetry producer circuits associated with the respective cores and communicated in telemetry data packets over the internal communication network to the telemetry consumer circuit to be stored in the telemetry memory. The telemetry consumer circuit is configured to store telemetry data in received telemetry data packets in a buffer entry in the telemetry memory corresponding to a current epoch (i.e., the same epoch) in which the telemetry data was received. An epoch is defined as the time it is expected to take for telemetry data associated with all the cores to be collected and communicated to be received by the telemetry consumer circuit. In this regard, the telemetry consumer circuit is configured to track receipt of telemetry data associated with the cores from received telemetry data packets in a given current epoch, and store the telemetry data in the telemetry memory corresponding to the current epoch. In this manner, telemetry data associated with the multiple cores for the same epoch are aligned in the telemetry memory by being stored in the same buffer entry corresponding to the epoch in which such was received. This allows determination of the state and performance of the processor-based system based on telemetry data relating to the same time period. The telemetry data circuits may also be configured to collect and provide telemetry data for its associated core each time a power state and/or performance state of its associated core is changed or other hardware related events occur.

The volume of telemetry data packets combined with other bus traffic communicated to the internal communications bus may cause network congestion in the internal communication network. Network congestion can cause delay in routing telemetry data packets to the telemetry memory as well as the inability to receive new data packets, referred to as network backpressure. In this instance, telemetry data for the cores for a given time window may not be timely received in the telemetry memory or even received in the event of telemetry data being dropped without transmission in a telemetry data packet on the internal communication bus. In an example, if the congestion in the internal communication network continues such that currently buffered telemetry data in a telemetry producer circuit cannot be transmitted in telemetry data packets onto the internal communication network, newly received telemetry data in such telemetry producer circuits may be unable to be stored and as a result, dropped. This can negatively impact the ability to determine performance characteristics of the processor-based system for the given time window. In this regard, the dropped telemetry data will result in missing telemetry data for its associated core being present in the telemetry memory for a given epoch. This can result in missing telemetry data in the telemetry memory leading to a continued inability to determine accurate performance characteristics of the processor-based system until the network congestion is resolved.

In this regard, in exemplary aspects disclosed herein, to avoid the issue of analyzing telemetry data in the telemetry memory for a given epoch that may include missing and thus incomplete telemetry data, such as due to network congestion, the telemetry consumer circuit is configured to track timing of receipt of telemetry data packets with an expected epoch received from the internal communication network. Because certain telemetry data packets are generated on a known periodic basis to be received by the telemetry consumer circuit within a current epoch, the telemetry consumer circuit can determine if all expected telemetry data packets for a given epoch have been timely received. If one or more telemetry data packets for a given epoch have not been timely received, this means the epoch corresponding to the epoch is incomplete and may be deemed an underflow condition by the telemetry consumer circuit. The underflow condition in the telemetry consumer circuit may have been a result of dropped telemetry data in a telemetry producer circuit as an overflow condition due to network backpressure, i.e., an inability to transmit a next buffered or non-buffered telemetry data onto the internal communication network. In this manner, the telemetry consumer circuit is in essence decoupled from the production of telemetry data packets by the telemetry producer circuits in response to the underflow condition. In response to all expected telemetry data packets associated with the cores being timely received within an expected epoch for a current epoch, the telemetry consumer circuit is configured to record an epoch status for the current epoch as the telemetry memory having complete telemetry data. However, in response to any expected telemetry data packets associated with the cores not being timely received within a current epoch, the telemetry consumer circuit is configured to record an epoch status for such a current epoch as having incomplete telemetry data. The telemetry consumer circuit can still store telemetry data received outside an epoch in the telemetry memory. The telemetry consumer circuit will continue to receive and record telemetry data for received telemetry data packets in the telemetry memory aligned for their respective epochs in which they were received and track their epoch statuses as incomplete or complete. If another underflow condition is detected for the next or any subsequent epochs, the telemetry consumer circuit will again detect missing telemetry data for a given epoch and record an incomplete status for the epoch.

In this manner, the telemetry consumer circuit has the ability to detect underflow conditions for epochs which allows for the ability of the telemetry consumer circuit to record related epoch statuses for such epochs to withstand missing telemetry data from dropped telemetry data due to network congestion. The telemetry data circuits still continue to collect and produce telemetry data even if there is not enough space in the telemetry producer circuits to buffer such telemetry data due to network congestion. However, the telemetry producer circuits drop the newly received telemetry data without generating new telemetry data packets for newly received telemetry data in response to network congestion. Again, the telemetry consumer circuit having the ability to detect an incomplete epoch allows the telemetry consumer circuit to withstand missing telemetry data due to dropped telemetry data. Also, the telemetry producer circuit does not have to handle restoration of dropped telemetry data due to network congestion. This is because the epoch in which an underflow condition occurred will be detected and managed by the telemetry consumer circuit such that the telemetry data stored in a buffer entry for the relevant epoch in the telemetry memory is known to have possibly have incomplete telemetry data. The telemetry consumer circuit stores telemetry data in the telemetry memory in a manner that results in telemetry data in a buffer entry for an epoch to be known to have complete telemetry data. Thus, the management processor will have the ability to analyze complete telemetry data for a given epoch in the processor-based system to more accurately control performance parameters in the processor-based system to manage performance in the processor-based system. If any telemetry data is missing for a given epoch, a complete view of the performance characteristics for such epoch may not be possible.

In another example, the telemetry data circuits associated with the cores may also be configured to collect and provide telemetry data associated with a core(s) that is randomly generated asynchronously and thus is not correlated to a specific time period. Thus, this asynchronous telemetry data does not have to be stored in time alignment in a corresponding epoch in the telemetry memory of the telemetry consumer circuit. For example, this asynchronous telemetry data may not be environmental data that is subject to change without being specially reconfigured by a management processor in the processor-based system. This asynchronous telemetry data can include the performance state (e.g., supply voltage and frequency setting) associated with a given core(s) that was previously configured for operation of the core(s) as an example. In another example, this asynchronous telemetry data can include the other messaging data associated with a given core(s). The telemetry producer circuits associated with the cores are also configured to buffer and communicate received asynchronous telemetry data for its associated core as telemetry data packets over the internal communication network to the telemetry consumer circuit to be stored in the telemetry memory for access. However, the telemetry consumer circuit does not have to ensure that this data is time aligned based on an epoch in the telemetry memory. Thus, this asynchronous telemetry data can be analyzed without sensitivity to time alignment issues to also manage related performance parameters in the processor-based system to manage performance of the processor-based system.

Note that the telemetry memory of the telemetry consumer circuit can be organized in different manners. In one example, the telemetry memory can be partitioned such that the same type of telemetry data is stored in entries within a dedicated partition. The telemetry memory can be organized to also store lossy telemetry data. Also, in another example, the entries in the telemetry memory are organized to be compatible with their partitioned type of telemetry data to be stored. For example, if telemetry data contains telemetry information for a single core, each buffer entry is configured to store telemetry data at a resolution of a single core. In another example, if telemetry data contains telemetry data for a cluster of cores (e.g., two (2) cores in the same tile), each entry is configured to store telemetry data at a resolution of the core cluster.

In this regard, in one exemplary aspect, a processor-based system is provided. The processor-based system comprises an internal communication network; a plurality of processor cores (cores) communicatively coupled to the internal communication network; a telemetry memory comprising a plurality of buffer entries; and a timer circuit configured to generate periodic timer signals each corresponding to a synchronous sampling time window of a plurality of synchronous sampling time windows. The processor-based system is configured to: receive telemetry data relating to a performance characteristic of an assigned one or more cores of the plurality of cores in the synchronous sampling time window; and transmit telemetry data packets comprising the telemetry data onto the internal communication network in the processor-based system. The processor-based system also comprises a telemetry consumer circuit configured to: define a current epoch time window defining an epoch within each synchronous sampling time window of the plurality of synchronous sampling time windows; receive the telemetry data packets routed in the internal communication network; store the telemetry data for the received telemetry data packets in a buffer entry of the plurality of buffer entries in the telemetry memory corresponding to the epoch; determine whether complete telemetry data packets for each of the plurality of cores are received in the epoch; and in response to determining complete receipt of telemetry data packets for each of the plurality of cores in the epoch, update an epoch status in an epoch status indicator corresponding to the epoch with a complete status.

In another exemplary aspect, a method of track timing of receipt of telemetry data packets relating to a plurality of processor cores (cores) in a processor-based system is provided. The method comprises receiving telemetry data relating to a performance characteristic of an assigned one or more cores of a plurality of cores communicatively coupled to an internal communication network in the processor-based system in a synchronous sampling time window of a plurality of synchronous sampling time windows; transmitting telemetry data packets comprising the telemetry data onto the internal communication network; defining a current epoch time window defining an epoch within each synchronous sampling time window of the plurality of synchronous sampling time windows; receiving the telemetry data packets routed in the internal communication network; storing the telemetry data for the received telemetry data packets in a buffer entry of a plurality of buffer entries in a telemetry memory corresponding to the epoch; determining whether complete telemetry data packets for each of the plurality of cores are received in the epoch; and in response to determining complete receipt of telemetry data packets for each of the plurality of cores in the epoch, updating an epoch status in an epoch status indicator corresponding to the epoch with a complete status.

In another exemplary aspect, a non-transitory computer-readable medium having stored thereon computer executable instructions, which when executed by a processor in a processor-based system comprising an internal communication network, a plurality of processor cores (cores) communicatively coupled to the internal communication network, a telemetry memory comprising a plurality of entries, cause the processor to: receive telemetry data relating to a performance characteristic of an assigned one or more cores of the plurality of cores in a synchronous sampling time window of a plurality of synchronous sampling time windows; transmit telemetry data packets comprising the telemetry data onto the internal communication network; define a current epoch time window defining an epoch within each synchronous sampling time window of the plurality of synchronous sampling time windows; receive the telemetry data packets routed in the internal communication network; store the telemetry data for the received telemetry data packets in a buffer entry of a plurality of buffer entries in a telemetry memory corresponding to the epoch; determine whether complete telemetry data packets for each of the plurality of cores are received in the epoch; and in response to determining complete receipt of telemetry data packets for each of the plurality of cores in the epoch, update an epoch status in an epoch status indicator corresponding to the epoch with a complete status.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram of an exemplary processor-based system that includes a central processing unit (CPU) that includes a plurality of processor cores (“cores”) communicatively coupled to an internal communication network, and an exemplary telemetry data system configured to tracking receipt of telemetry data stored in the telemetry memory 128 relating to performance characteristics of the cores within an epoch, to facilitate indicating if complete telemetry data was received for the epoch, to more accurately control performance parameters in the processor-based system to enhance performance;

FIG. 2 is a block diagram illustrating more exemplary detail of the cores in the CPU of the processor-based system in FIG. 1, wherein telemetry producer circuits each associated with a core generate telemetry data packets with collected telemetry data for an associated core to be transmitted on the internal communication network to be received by a telemetry consumer circuit;

FIG. 3 is a block diagram illustrating more exemplary detail of the telemetry data system in the processor-based system in FIG. 1 illustrating telemetry producer circuits configured to transmit telemetry data in telemetry data packets for its associated core onto the internal communication network and a telemetry consumer circuit configured to receive the telemetry data packets and track receipt of telemetry data relating to performance characteristics of the cores collected for the same epoch;

FIG. 4A is a block diagram illustrating more exemplary detail of the internal communication network in the processor-based system in FIGS. 1-3;

FIG. 4B is a diagram illustrating exemplary detail of a network node in the internal communication network in FIG. 4A, wherein the network node is configured to forward telemetry data packets to the telemetry consumer circuit in the telemetry data system in FIG. 3;

FIGS. 5A and 5B are block diagrams of portions of an exemplary telemetry producer circuit that can be a telemetry producer circuit in FIG. 3, wherein the telemetry producer circuit is configured to receive telemetry data to be transmitted as telemetry data packets onto the internal communication network in the internal communication network;

FIG. 6A is a block diagram of telemetry data provided from the internal communication network in FIGS. 4A and 4B coupled to an exemplary telemetry memory in FIG. 3;

FIG. 6B is a block diagram of an exemplary organization of the telemetry memory in the telemetry data system in FIGS. 1 and 3 by telemetry data type;

FIG. 7 is a block diagram of an exemplary organization of entries in the telemetry memory in FIG. 6B for storing time-aligned telemetry data and epoch status indicator, wherein each buffer entry in the telemetry memory is assigned for storing telemetry data from multiple received telemetry data packets containing the telemetry data for the same synchronous, sampling time window;

FIG. 8 is a timing diagram illustrating exemplary start and expiration states of an epoch expiration timer that can be used by the telemetry data system in FIG. 3, for tracking receipt of telemetry data within a given epoch;

FIG. 9 is a block diagram illustrating timer registers that can be used to track the epoch expiration signal and epoch expiration buffer signal in FIG. 8;

FIG. 10 is a flowchart illustrating an exemplary process of the telemetry data system in a processor-based system, including the telemetry data system in a processor-based system in FIGS. 1-3, tracking receipt of telemetry data stored in the telemetry memory relating to performance characteristics of the cores within an epoch, to facilitate indicating if complete telemetry data was received for the epoch;

FIG. 11 is a diagram illustrating exemplary processes that can be performed by the telemetry consumer circuit in FIG. 3, for tracking receipt of telemetry data tracking receipt of telemetry data stored in the telemetry memory 128 relating to performance characteristics of the cores within an epoch, to facilitate indicating if complete telemetry data was received for the epoch;

FIG. 12A illustrates exemplary entries that can be configured in the telemetry memory in FIGS. 1, 3, and 6B for storing temperature telemetry data collected in the same time window in a time-aligned organization from received telemetry data packets;

FIG. 12B illustrates an exemplary data format for a temperature telemetry data packet produced in the processor-based system in FIGS. 1-3;

FIG. 12C illustrates an exemplary data format for a voltage telemetry data packet produced in the processor-based system in FIGS. 1-3;

FIG. 13A illustrates exemplary entries that can be configured in the telemetry memory in FIGS. 1, 3, and 6B for storing current telemetry data in a time-aligned organization from received telemetry data packets;

FIG. 13B illustrates an exemplary data format for a current telemetry data packet produced in the processor-based system in FIGS. 1-3; and

FIG. 14 is a block diagram of another exemplary processor-based system that can be the processor-based system in FIGS. 1-3, wherein the processor-based system includes a processing unit (PU) that includes a plurality of processor cores (“cores”) communicatively coupled to an internal communication network, and an exemplary telemetry data system configured to track receipt of telemetry data stored in the telemetry memory 128 relating to performance characteristics of the cores within an epoch, to facilitate indicating if complete telemetry data was received for the epoch, to more accurately control performance parameters in the processor-based system to enhance performance, including according to, but not limited to, the processes in FIGS. 10 and 11.

### DETAILED DESCRIPTION

Exemplary aspects disclosed herein include decoupling of telemetry data production from network transmission during network congestion in a processor-based system. The processor-based system includes a processing unit (PU) (e.g., a central processing unit (CPU)) that includes one or more processor cores (“cores”) that can each execute computer program instructions to perform tasks. The processor-based system may be provided as a system-on-a-chip (SoC) as an example, wherein the processor(s) is incorporated into a single integrated circuit (IC) chip along with other supporting computing components (e.g., memory, communications buses, input/output ports, etc.). The processor-based system includes an internal communication network (e.g., a fabric mesh network) that interfaces the cores with supporting computing components to allow the cores to make requests to the supporting computing components as part of carrying out computing tasks, and vice versa (e.g., snoop requests). The processor-based system is also configured to collect telemetry data that represent or affect performance characteristics of the cores (e.g., temperature, voltage, consumed current, etc.). Telemetry data circuits, which each may be associated with a given core or as part of the core, can be provided and configured to collect telemetry data for its associated core and provide such telemetry data to a telemetry producer circuit associated with the core. The telemetry producer circuits associated with the cores are each configured to communicate the received telemetry data for its associated core as telemetry data packets over the internal communication network. The internal communication network is configured to route the telemetry data packets to a telemetry consumer circuit in the processor-based system that includes or interfaces with a telemetry memory that may be a shared access memory (e.g., a random access memory (RAM) buffer). The telemetry consumer circuit is configured to store the telemetry data in the telemetry memory such that the telemetry data can independently be accessed from the telemetry memory to be analyzed by a separate processor(s) to determine a performance state of a core and/or the overall processor-based system and/or if a performance parameter(s) of a core and/or the overall processor-based system should be changed to control their performance. For example, telemetry data regarding power consumption of a core(s) may be used to manage a power state for a core(s) (e.g., idle, normal power state, high power state) and/or the overall processor-based system to be within desired power limits. The telemetry data may also be used to control a performance state of the core(s) (e.g., supply voltage and frequency) to improve system performance and/or to manage power consumption of a core(s).

In exemplary aspects, telemetry data circuits associated with the cores are each configured to periodically collect telemetry data associated with their cores. In this manner, the telemetry data circuits are controlled to collect telemetry data relating to the cores in an ongoing, periodic fashion so that telemetry data associated with the cores is available to be analyzed for a given time period. This also allows determination of the state and performance of a plurality of the cores in the processor-based system based on their telemetry data collected in the same time period. For example, it may be desired to understand and analyze telemetry data associated with multiple cores that was collected in the same time period to have an understanding of the state of each of those cores for that time period. The collected telemetry data is provided to respective telemetry producer circuits associated with the respective cores and communicated in telemetry data packets over the internal communication network to the telemetry consumer circuit to be stored in the telemetry memory. The telemetry consumer circuit is configured to store telemetry data in received telemetry data packets in a buffer entry in the telemetry memory corresponding to a current epoch (i.e., the same epoch) in which the telemetry data was received. An epoch is defined as the time it is expected to take for telemetry data associated with all the cores to be collected and communicated to be received by the telemetry consumer circuit. In this regard, the telemetry consumer circuit is configured to track receipt of telemetry data associated with the cores from received telemetry data packets in a current epoch, and store the telemetry data in the telemetry memory corresponding to the current epoch. In this manner, telemetry data associated with the multiple cores for the same epoch are aligned in the telemetry memory by being stored in the same buffer entry corresponding to the epoch in which such was received. This allows determination of the state and performance of the processor-based system based on telemetry data relating to the same time period. The telemetry data circuits may also be configured to collect and provide telemetry data for its associated core each time a power state and/or performance state of its associated core is changed or other hardware related events occur.

The volume of telemetry data packets combined with other bus traffic communicated to the internal communications bus may cause network congestion in the internal communication network. Network congestion can cause delay in routing telemetry data packets to the telemetry memory as well as the inability to receive new data packets, referred to as network backpressure. In this instance, telemetry data for the cores for a given time window may not be timely received in the telemetry memory or even received in the event of telemetry data being dropped without transmission in a telemetry data packet on the internal communication bus. In an example, if the congestion in the internal communication network continues such that currently buffered telemetry data in a telemetry producer circuit cannot be transmitted in telemetry data packets onto the internal communication network, newly received telemetry data in such telemetry producer circuits may be unable to be stored and as a result, dropped. This can negatively impact the ability to determine performance characteristics of the processor-based system for the given time window. In this regard, the dropped telemetry data will result in missing telemetry data for its associated core being present in the telemetry memory for a given epoch. This can result in missing telemetry data in the telemetry memory leading to a continued inability to determine accurate performance characteristics of the processor-based system until the network congestion is resolved.

In this regard, in exemplary aspects disclosed herein, to avoid the issue of analyzing telemetry data in the telemetry memory for a given epoch that may include missing and thus incomplete telemetry data, such as due to network congestion, the telemetry consumer circuit is configured to track timing of receipt of telemetry data packets with an expected epoch received from the internal communication network. Because certain telemetry data packets are generated on a known periodic basis to be received by the telemetry consumer circuit within a current epoch, the telemetry consumer circuit can determine if all expected telemetry data packets for a given epoch have been timely received. If one or more telemetry data packets for a given epoch have not been timely received, this means the epoch corresponding to the epoch is incomplete and may be deemed an underflow condition by the telemetry consumer circuit. The underflow condition in the telemetry consumer circuit may have been a result of dropped telemetry data in a telemetry producer circuit as an overflow condition due to network backpressure, i.e., an inability to transmit a next buffered or non-buffered telemetry data onto the internal communication network. In this manner, the telemetry consumer circuit is in essence decoupled from the production of telemetry data packets by the telemetry producer circuits in response to the underflow condition. In response to all expected telemetry data packets associated with the cores being timely received within an expected epoch for a current epoch, the telemetry consumer circuit is configured to record an epoch status for the current epoch as the telemetry memory having complete telemetry data. However, in response to any expected telemetry data packets associated with the cores not being timely received within a current epoch, the telemetry consumer circuit is configured to record an epoch status for such a current epoch as having incomplete telemetry data. The telemetry consumer circuit can still store telemetry data received outside an epoch in the telemetry memory. The telemetry consumer circuit will continue to receive and record telemetry data for received telemetry data packets in the telemetry memory aligned for their respective epochs in which they were received and track their epoch statuses as incomplete or complete. If another underflow condition is detected for the next or any subsequent epoch, the telemetry consumer circuit will again detect missing telemetry data for a given epoch and record an incomplete status for the epoch.

In this manner, the telemetry consumer circuit has the ability to detect underflow conditions in epochs which allows for the ability of the telemetry consumer circuit to record related epoch statuses for such epoch to withstand missing telemetry data from dropped telemetry data due to network congestion. The telemetry data circuits still continue to collect and produce telemetry data even if there is not enough space in the telemetry producer circuits to buffer such telemetry data due to network congestion. However, the telemetry producer circuits drop the newly received telemetry data without generating new telemetry data packets for newly received telemetry data in response to network congestion. Again, the telemetry consumer circuit having the ability to detect an incomplete epoch allows the telemetry consumer circuit to withstand missing telemetry data due to dropped telemetry data. Also, the telemetry producer circuit does not have to handle restoration of dropped telemetry data due to network congestion. This is because the epoch in which an underflow condition occurred will be detected and managed by the telemetry consumer circuit such that the telemetry data stored in a buffer entry for the relevant epoch in the telemetry memory is known to have possibly have incomplete telemetry data. The telemetry consumer circuit stores telemetry data in the telemetry memory in a manner that results in telemetry data in a buffer entry for an epoch to be known to have complete telemetry data. Thus, the management processor will have the ability to analyze complete telemetry data for a given epoch in the processor-based system to more accurately control performance parameters in the processor-based system to manage performance in the processor-based system. If any telemetry data is missing for a given epoch, a complete view of the performance characteristics for such epoch may not be possible.

In another example, the telemetry data circuits associated with the cores may also be configured to collect and provide telemetry data associated with a core(s) that is randomly generated asynchronously and thus is not correlated to a specific time period. Thus, this asynchronous telemetry data does not have to be stored in time alignment in a corresponding epoch in the telemetry memory of the telemetry consumer circuit. For example, this asynchronous telemetry data may not be environmental data that is subject to change without being specially reconfigured by a management processor in the processor-based system. This asynchronous telemetry data can include the performance state (e.g., supply voltage and frequency setting) associated with a given core(s) that was previously configured for operation of the core(s) as an example. In another example, this asynchronous telemetry data can include the other messaging data associated with a given core(s). The telemetry producer circuits associated with the cores are also configured to buffer and communicate received asynchronous telemetry data for its associated core as telemetry data packets over the internal communication network to the telemetry consumer circuit to be stored in the telemetry memory for access. However, the telemetry consumer circuit does not have to ensure that this data is time aligned based on an epoch in the telemetry memory. Thus, this asynchronous telemetry data can be analyzed without sensitivity to time alignment issues to also manage related performance parameters in the processor-based system to manage performance of the processor-based system.

Note that the telemetry memory of the telemetry consumer circuit can be organized in different manners. In one example, the telemetry memory can be partitioned such that the same type of telemetry data is stored in entries within a dedicated partition. The telemetry memory can be organized to also store lossy telemetry data. Also, in another example, the entries in the telemetry memory are organized to be compatible with their partitioned type of telemetry data to be stored. For example, if telemetry data contains telemetry information for a single core, each buffer entry is configured to store telemetry data at a resolution of a single core. In another example, if telemetry data contains telemetry data for a cluster of cores (e.g., two (2) cores in the same tile), each entry is configured to store telemetry data at a resolution of the core cluster.

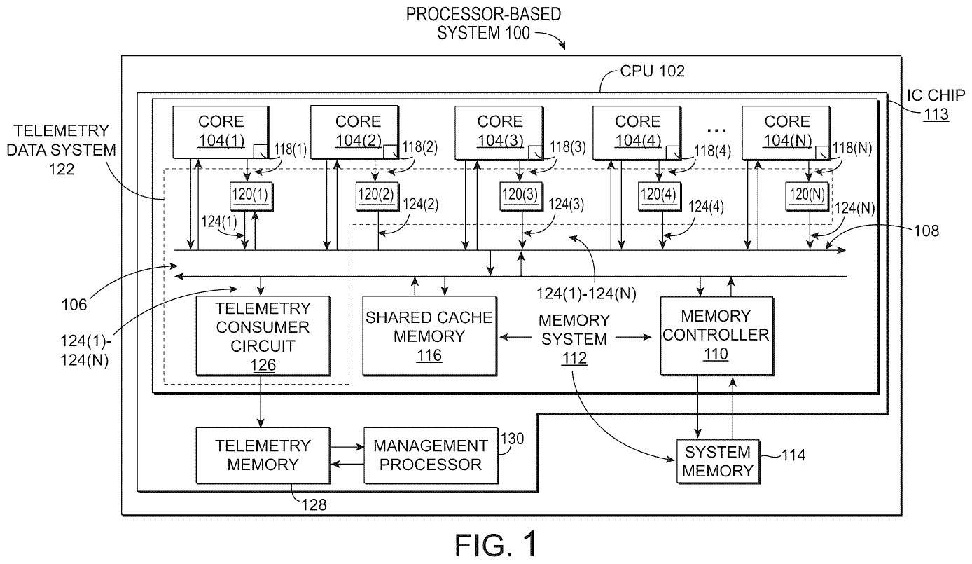

In this regard, FIG. 1 is a block diagram of an exemplary processor-based system 100 that includes a central processing unit (CPU) 102 that includes plurality of processor cores 104(1)-104(N), also referred to herein as “cores” 104(1)-104(N). The cores 104(1)-104(N) are communicatively coupled to an internal communication network 106, which may be a mesh network. The cores 104(1)-104(N) are each configured to provide requests 108 (e.g., memory access requests) to be serviced by other peripheral computing devices that are part of the processor-based system 100. For example, these requests 108 could be memory access requests that are communicated through the internal communication network 106 to a memory controller 110 that is part of a memory system 112 of the processor-based system 100, wherein the memory controller 110 services such memory access requests 108 through a system memory 114 as part of the memory system 112. For example, the CPU 102 may be included in a single IC chip 113, such as a system-on-a-chip (SoC). The memory system 112 may also include cache memory that is private to a respective core 104(1)-104(N) and/or shared cache memory 116 that is accessed through the internal communication network 106 and which is accessed before a resulting cache miss will result in a memory access request 108 being communicated to the memory controller 110.

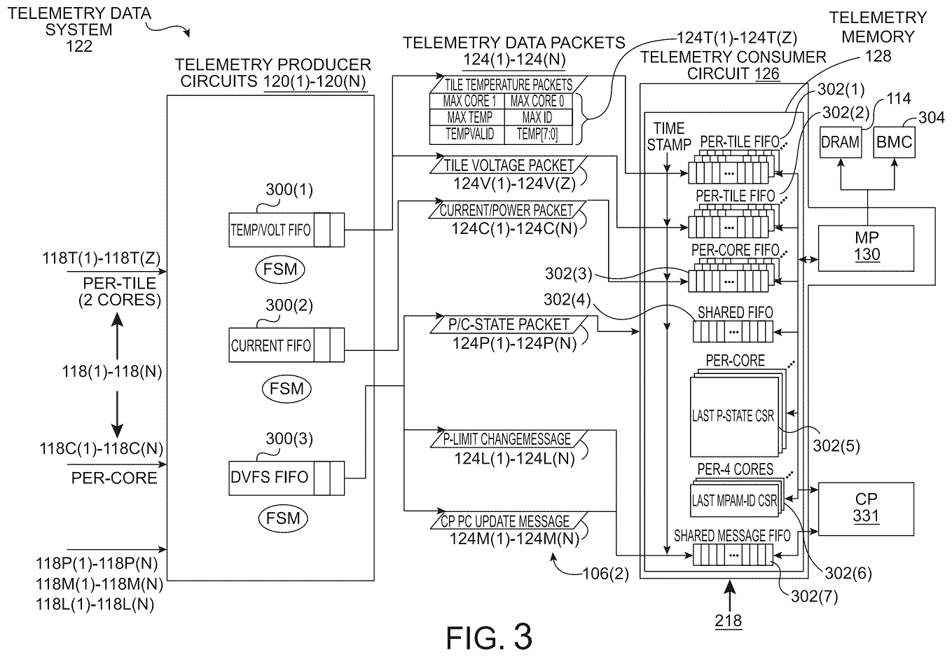

In this example, and as discussed in more detail below, the cores 104(1)-104(N) are each configured to synchronously, periodically collect respective telemetry data 118(1)-118(N) relating to a performance characteristic(s) of their respective core 104(1)-104(N). The cores 104(1)-104(N) are configured to provide this telemetry data 118(1)-118(N) to a respective telemetry producer circuit 120(1)-120(N) associated with a respective, assigned core 104(1)-104(N) in a telemetry data system 122. Each telemetry producer circuit 120(1)-120(N) is configured to package respective received telemetry data 118(1)-118(N) into respective telemetry data packets 124(1)-124(N) that are then transmitted over the internal communication network 106 to be received by a telemetry consumer circuit 126. As discussed in more detail below, the telemetry consumer circuit 126 is configured to track receipt of telemetry data 118(1)-118(N) stored in the telemetry memory 128 in a time aligned manner according to epoch, wherein the telemetry data 118(1)-118(N) relates to performance characteristics of the cores 104(1)-104(N). This tracking performed by the telemetry consumer circuit 126 can be used to facilitate indicating if complete telemetry data 118(1)-118(N) for the cores 104(1)-104(N) was received for a given current epoch. In this example, the telemetry memory 128 is included in the CPU 102. The telemetry memory 128 can be separate memory in the processor-based system 100 or included or partitioned from the system memory 114. For example, storing the telemetry data 118(1)-118(N) time aligned in the telemetry memory 128 allows a separate control processor (see FIG. 3 below) to access the telemetry data 118(1)-118(N) to make decisions about controlling performance parameters in the processor-based system 100 to enhance performance based on telemetry data collected in a common synchronous time period. The control processor 331 is included in the CPU 102 is included in the CPU 102 in this example. Because the telemetry data 118(1)-118(N) is stored time aligned according to epochs, this ensures that a control processor can access complete telemetry data 118(1)-118(N) that was collected relating to the cores 104(1)-104(N) in a given time window to have the ability to analyze complete telemetry data 118(1)-118(N) for such time window to more accurately control performance parameters in the processor-based system 100. If a control processor were to analyze telemetry data that includes missing telemetry data 118(1)-118(N) (e.g., due to network congestion in the internal communication network 106) for a given time window, a complete and accurate view of the performance characteristics for such time window may not be possible.

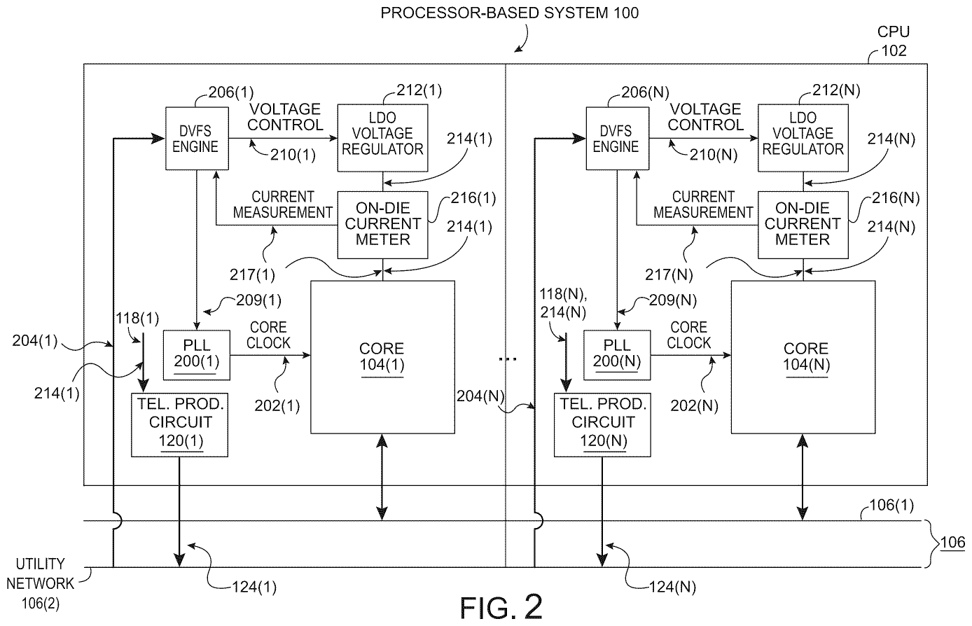

FIG. 2 is a block diagram illustrating more exemplary detail of the cores 104(1)-104(N) in the processor-based system 100 in FIG. 1. FIG. 2 represents an example of exemplary components that can be associated with the cores 104(1)-104(N) that involve collecting respective telemetry data 118(1)-118(N) as “producer” circuits and providing such to respective telemetry producer circuits 120(1)-120(N) to be packetized as the respective telemetry data packets 124(1)-124(N).

In this regard, as shown in FIG. 2, each core 104(1)-104(N) is configured to communicate non-telemetry data related requests (e.g., memory requests) over an internal network 106(1) that is part of the internal communication network 106 in this example. The CPU 102 includes a respective phase locked loop (PLL) circuit 200(1)-200(N) for each core 104(1)-104(N) of the CPU 102. The PLL circuits 200(1)-200(N) supply a respective core clock signal 202(1)-202(N) to the cores 104(1)-104(N) to clock operation of the cores 104(1)-104(N) at a frequency according to a performance state of the core 104(1)-104(N). The performance state of the cores 104(1)-104(N) is controlled by a performance state message 204(1)-204(N) communicated to a respective dynamic voltage frequency scaling (DVFS) circuit 206(1)-206(N) that is associated with each core 104(1)-104(N) over a utility network 106(2) that may be a separate bus as part of the internal communication network 106. For example, a control processor provided in the processor-based system 100 in FIG. 1 may be responsible for controlling the performance state of the cores 104(1)-104(N) based on the telemetry data 118(1)-118(N) stored in time aligned fashion according to epochs in the telemetry memory 128 by the telemetry consumer circuit 126 in FIG. 1. The DVFS circuits 206(1)-206(N) are each configured to provide frequency control signals 209(1)-209(N) to cause the PLL circuit 200(1)-200(N) to control the frequency of the respective core clock signal 202(1)-202(N) to clock the respective core 104(1)-104(N) according to the performance state message 204(1)-204(N) set for the respective core 104(1)-104(N). The DVFS circuits 206(1)-206(N) are also each configured to provide voltage control signals 210(1)-210(N) to control a respective voltage regulator 212(1)-212(N) to generate a respective core voltage 214(1)-214(N) to power the core 104(1)-104(N) at a voltage according to the performance state in the performance state message 204(1)-204(N) set for the respective core 104(1)-104(N). The core voltage 214(1)-214(N) can also be measured and provided to the respective telemetry producer circuits 120(1)-120(N) as a form of voltage telemetry data 118(1)-118(N) regarding the voltage level of the respective cores 104(1)-104(N) that can be incorporated in telemetry data packets 124(1)-124(N) to be provided to the telemetry consumer circuit 126 (see FIG. 1).

Also, as shown in FIG. 2, the processor-based system 100 includes an on-die current measurement circuit 216(1)-216(N) to measure current consumption and generate a corresponding current measurement signal 217(1)-217(N) for each respective core 104(1)-104(N). The current measurement signal 217(1)-217(N) is provided to the respective DVFS circuit 206(1)-206(N) to control the frequency of the core clock signal 202(1)-202(N) and/or voltage of the core voltage 214(1)-214(N) to control the performance level of the respective core 104(1)-104(N). The current measurement signal 217(1)-217(N) is also provided to the respective telemetry producer circuit 120(1)-120(N) as part of telemetry data 118(1)-118(N). In this regard, the on-die current measurement circuit 216(1)-216(N) are considered to be an example of telemetry data circuits that are configured to collect telemetry data 118(1)-118(N). In this manner, the telemetry producer circuits 120(1)-120(N) are able to provide the current consumption from the current measurement signal 217(1)-217(N) as telemetry data 118(1)-118(N) in telemetry data packets 124(1)-124(N) to be transmitted over the utility network 106(2) to be received by the telemetry consumer circuit 126 shown in FIG. 1. The telemetry producer circuits 120(1)-120(N) may also be configured to receive and transmit other types of telemetry data 118(1)-118(N) in telemetry data packets 124(1)-124(N) over the utility network 106(2) to the telemetry consumer circuit 126, such as temperature associated with a respective core 104(1)-104(N) and voltage of a respective core 104(1)-104(N).

FIG. 3 is a block diagram illustrating more exemplary detail of the telemetry data system 122 in the processor-based system 100 in FIG. 1. As shown in FIG. 3, the telemetry producer circuits 120(1)-120(N) are each configured to transmit received respective telemetry data 118(1)-118(N) having telemetry information regarding the respective cores 104(1)-104(N). In this example, certain telemetry data 118C(1)-118C(N), such as current consumption data, may be provided by each core 104(1)-104(N) on a per core basis. Other telemetry data 118T(1)-118T(Z), such as temperature and voltage data, may be provided for a core 104(1)-104(N) or tile of multiple cores 104(1)-104(N). The telemetry producer circuits 120(1)-120(N) each include the shown buffer circuits 300(1)-300(3) that are configured to store received telemetry data 118(1)-118(N) as it is received to prepare to generate telemetry data packets 124(1)-124(N) with such telemetry data 118(1)-118(N) to be communicated over the utility network 106(2) to the telemetry consumer circuit 126.

In this example, each telemetry producer circuit 120(1)-120(N) includes a first buffer circuit 300(1) as a FIFO circuit that is configured to store the received temperature telemetry data 118T(1)-118T(Z) on a per core 104(1)-104(N) tile basis. The first buffer circuit 300(1) is also configured to store voltage data from received voltage telemetry data 118V(1)-118V(Z) on a per core 104(1)-104(N) title basis. The telemetry producer circuits 120(1)-120(N) also each include a second buffer circuit 300(2) as a FIFO circuit that is configured to store current consumption data from received current consumption telemetry data 118C(1)-118C(N) on a per core 104(1)-104(N) basis. The telemetry producer circuits 120(1)-120(N) also each include a third buffer circuit 300(3) as a FIFO circuit that is configured to store performance telemetry data 118P(1)-118P(N) on a per core 104(1)-104(N) basis relating to performance state of the core 104(1)-104(N) that can be used to determine the actual performance state of each core 104(1)-104(N). The third buffer circuit 300(3) is also configured to store messaging telemetry data 118M(1)-118M(N) on a per core 104(1)-104(N) basis. The third buffer circuit 300(3) is also configured to store performance limit telemetry data 118L(1)-118L(N) on a per core 104(1)-104(N) basis.

With continuing reference to FIG. 3, the telemetry producer circuits 120(1)-120(N) are configured to generate respective temperature telemetry data packets 124T(1)-124T(Z) with temperature telemetry data for each core 104(1)-104(N) tile, which may include maximum temperature of each core 104(1)-104(N) in a given core 104(1)-104(N) tile, and max temperature of the entire core 104(1)-104(N) tile. The telemetry producer circuit 120 is also configured to generate voltage telemetry data packets 124V(1)-124V(Z) with voltage telemetry data for each core 104(1)-104(N) tile. The telemetry producer circuits 120(1)-120(N) are also configured to generate respective current consumption telemetry data packets 124C(1)-124C(N) with current consumption telemetry data for each core 104(1)-104(N). The telemetry producer circuits 120(1)-120(N) are also configured to generate other respective telemetry data packets 124(1)-124(N) that are not synchronous, meaning their respective telemetry data is not generated in response to a synchronous, sampling time window but generated asynchronously. These asynchronously generated telemetry data packets 124(1)-124(N) include generated performance state telemetry data packets 124P(1)-124P(N) with performance states of the cores 104(1)-104(N), performance limit telemetry data packets 124L(1)-124L(N), and other messaging telemetry data packets 124M(1)-124M (N) with messages generated by the cores 104(1)-104(N) for performing other administrative tasks related to controlling the cores 104(1)-104(N).

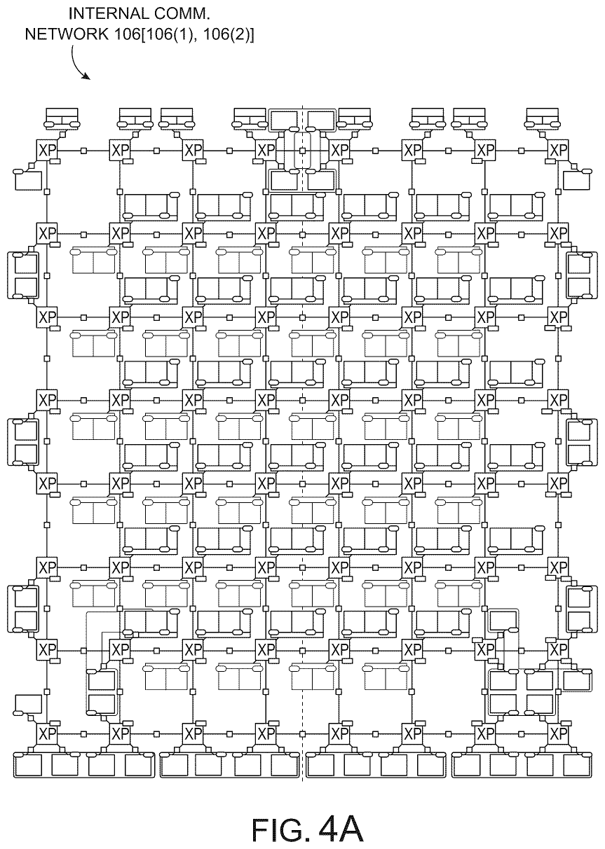

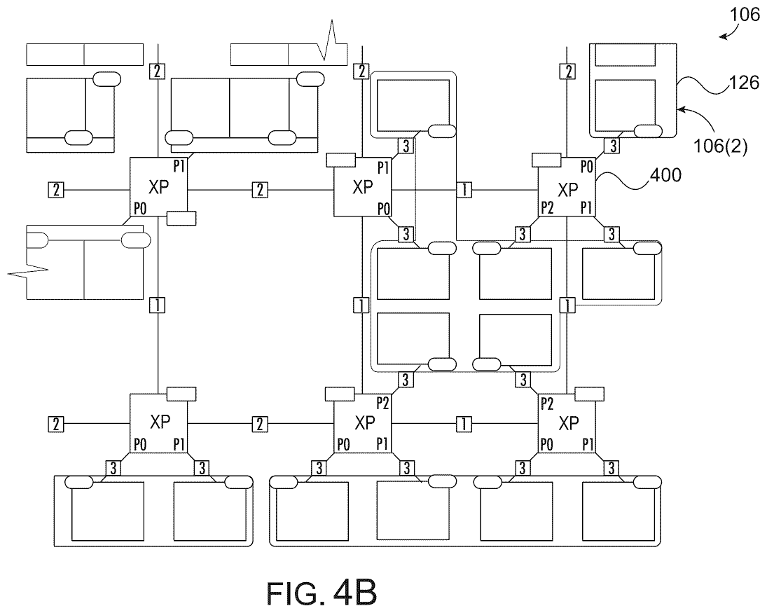

With continuing reference to FIG. 3, the telemetry producer circuits 120(1)-120(N) are configured to transmit the respective telemetry data packets 124(1)-124(N) onto the utility network 106(2) to be received by the telemetry consumer circuit 126. For example, FIG. 4A is a block diagram illustrating more exemplary detail of the utility network 106(2), which is shown as a mesh network with multiple network nodes XP that can manage propagating data through multiple data paths. FIG. 4B is a diagram illustrating exemplary detail of the utility network 106(2) as part of the internal communication network 106 in FIG. 4A, wherein a specified network node XP 400 is configured to be interfaced to the telemetry consumer circuit 126 to forward telemetry data packets 124(1)-124(N) to the telemetry consumer circuit 126 in the telemetry data system 122 in FIG. 3.

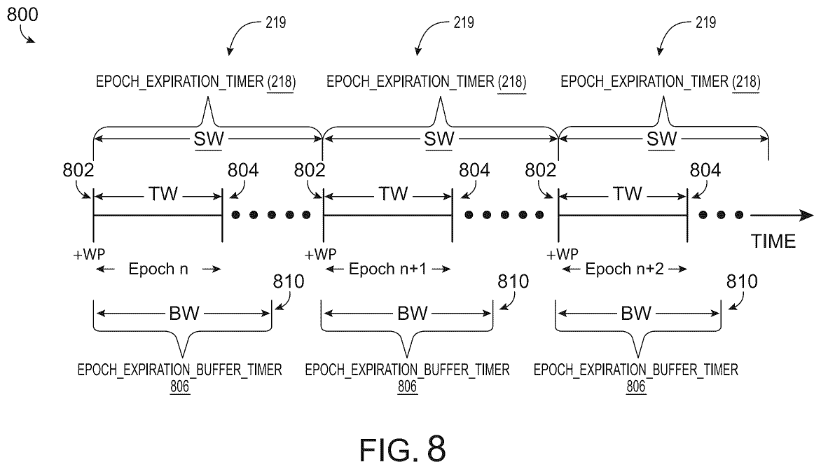

With reference back to FIG. 3, the telemetry consumer circuit 126 is configured to receive the telemetry data packets 124(1)-124(N) for a current epoch according to a tracked epoch and store the telemetry data 118(1)-118(N) from the received telemetry data packets 124(1)-124(N) in corresponding buffer circuits 302(1)-302(7). As discussed in more detail below with regard to FIG. 8, the telemetry consumer circuit 126 is configured to use an epoch expiration timer 218 to track epoch time windows for epochs. The telemetry consumer circuit 126 is configured to store the telemetry data 118(1)-118(N) from the telemetry data packets 124(1)-124(N) in the telemetry memory 128. As discussed above, the telemetry producer circuits 120(1)-120(N) as producer circuits are configured to receive and/or collect and communicate telemetry data 118(1)-118(N) synchronously for a sequential periodic time window. However, the volume of telemetry data 118(1)-118(N) communicated as telemetry data packets 124(1)-124(N) by the telemetry producer circuits 120(1)-120(N) are over the utility network 106(2) can cause network congestion in the utility network 106(2). Network congestion, also referred to as network backpressure, can cause delay in routing telemetry data packets 124(1)-124(N) to the telemetry consumer circuit 126 as well as the inability to receive new telemetry data packets 124(1)-124(N). In this instance, telemetry data 118(1)-118(N)) for a given epoch may not be timely received in the telemetry consumer circuit 126 or even received in the event of telemetry data being dropped in a telemetry producer circuit 120(1)-120(N), thus negatively impacting the ability to determine performance characteristics of all the cores 104(1)-104(N) in the processor-based system 100 for the given epoch. In this regard, any dropped telemetry data 118(1)-118(N) will result in the dropped telemetry data 118(1)-118(N) for its associated core 104(1)-104(N) not being stored in the telemetry memory 128 for its given epoch. This can result in missing telemetry data 118(1)-118(N) not being stored in the telemetry memory 128 leading to a continued inability to determine accurate performance characteristics of the processor-based system 100 until the network congestion is resolved.

However, as discussed in more detail below, to avoid the issue of analyzing telemetry data in the telemetry memory 128 for a given epoch that may include missing and thus incomplete telemetry data 118(1)-118(N), such as due to network congestion, the telemetry consumer circuit 126 is configured to track timing of receipt of telemetry data packets 124(1)-124(N) received from the utility network 106(2) based on a time stamp to correspond to a synchronous epoch in which the telemetry data 118(1)-118(N) was received. Because the telemetry data 118(1)-118(N) is collected and provided to the telemetry producer circuits 120(1)-120(N) on a known periodic basis within a defined time window, the telemetry consumer circuit 126 can determine if all expected telemetry data packets 124(1)-124(N) for a given epoch have been timely received. If one or more telemetry data packets 124(1)-124(N) for a given epoch have not been timely received, this is deemed an underflow condition by the telemetry consumer circuit 126. The underflow condition may have been a result of the message buffer in a telemetry producer circuits 120(1)-120(N) not being able to buffer a respective new telemetry data 118(1)-118(N) due to network backpressure. New received telemetry data 118(1)-118(N) may be dropped in the respective telemetry producer circuits 120(1)-120(N) in the presence of backpressure in the utility network 106(2).

In this manner, the telemetry consumer circuit 126 is in essence decoupled from the production of telemetry data packets 124(1)-124(N) by the telemetry producer circuits 120(1)-120(N) in response to the underflow condition in the telemetry consumer circuit 126. In response to all expected telemetry data packets 124(1)-124(N) being timely received within an expected epoch, the telemetry consumer circuit 126 is configured to record an epoch status for such epoch as the telemetry memory 128 having complete telemetry data 118(1)-118(N) for the epoch corresponding to the epoch. However, in response to any expected telemetry data packets 124(1)-124(N) not being timely received within an expected epoch, the telemetry consumer circuit 126 is configured to record an epoch status for such epoch corresponding to the epoch as having incomplete telemetry data 118(1)-118(N). The control processor 331 can be configured to access the telemetry memory 128 to use complete telemetry data 118(1)-118(N) for a given epoch stored therein to control a performance parameter(s) of the cores 104(1)-104(N) to control their performance. For example, if temperature telemetry data for a given core 104(1)-104(N) or core tile indicates a temperature beyond desired limits, the performance state of such core 104(1)-104(N) can be reduced to reduce temperature. If temperature telemetry data for a given core 104(1)-104(N) or core tile indicates a voltage or current consumption beyond desired limits, this may also be an indication that a core 104(1)-104(N) may exceed temperature limits, and thus the performance state of such core 104(1)-104(N) can also be reduced to reduce voltage or current consumption and thus temperature. In this regard, the control processor 331 may be configured to communicate an updated performance state of a core 104(1)-104(N) in a performance state message 204(1)-204(N) on the utility network 106(2) based on the analyzed telemetry data 118(1)-118(N) from the cores 104(1)-104(N) for a given epoch.

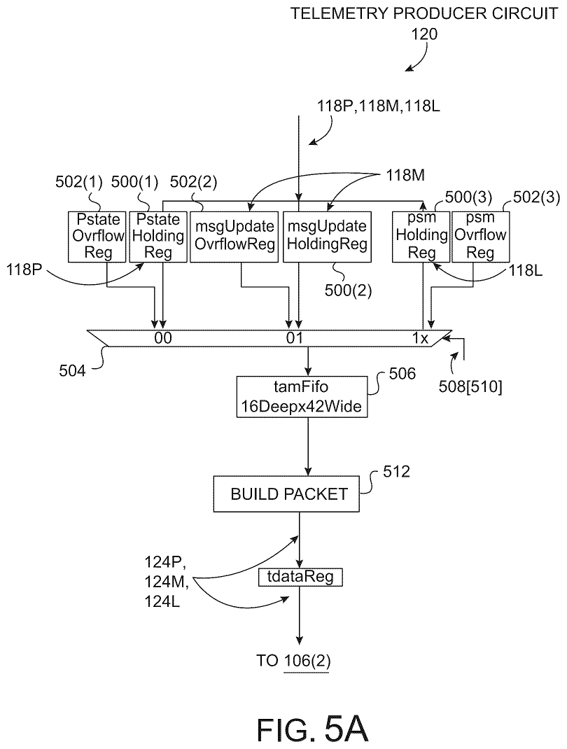

FIG. 5A is a block diagram of exemplary details of a portion of the telemetry producer circuit 120 for receiving, buffering, and transmitting received performance telemetry data 118P, messaging telemetry data 118M, and performance limit telemetry data 118L onto the utility network 106(2). The telemetry producer circuit 120 can be any of the telemetry producer circuits 120(1)-120(N) in FIGS. 1-3. The telemetry producer circuit 120 is configured to receive and buffer telemetry data 118P, 118M, 118L to be transmitted as a telemetry data packet 124 onto the utility network 106(2) based on its network congestion state. In this regard, as shown in FIG. 5A, the telemetry producer circuit 120 includes holding registers 500(1)-500(3) and associated respective overflow registers 502(1)-502(3) for each type of the telemetry data 118P, 118M, 118L discussed in FIG. 3. For example, the holding register 500(1) is for holding performance state telemetry data 118P. The holding register 500(2) is for holding messaging telemetry data 118M. The holding register 500(3) is for holding performance limit telemetry data 118L. Telemetry data to be packaged in a respective telemetry data packet 124P, 124M, 124L to be transmitted on the utility network 106(2) is held in the holding register 500(1)-500(3). The overflow registers 502(1)-502(3) may be single bit registers for example. Data representations of either an overflow condition (e.g., a bit set to logic ‘1’) or a non-overflow condition (e.g., a bit set to logic ‘0’) are updated in the overflow registers 502(1)-502(3) based on the overflow condition of the utility network 106(2). In an overflow condition, the telemetry data 118P, 118M, 118L present in a respective holding register 500(1)-500(3) is not packetized in a telemetry data packet 124 to be transmitted onto the utility network 106(2) due to network congestion.

With continuing reference to FIG. 5A, a multiplexer circuit 504 is configured to selectively provide telemetry data 118P, 118M, 118L in a selected holding register 500(1)-500(3) to a buffer circuit 506. This is to prepare such telemetry data 118P, 118M, 118L to be provided to a packet builder circuit 512 to generate a telemetry data packet 124P, 124M, 124L with the respective telemetry data 118P, 118M, 118L to be transmitted on the utility network 106(2) to be received by the telemetry consumer circuit 126 in FIG. 3. The multiplexer circuit 504 is controlled in response to a network congestion signal 508 indicating a network congestion state 510 of the internal communication network 106. The network congestion signal 508 may be generated as a result of an overflow condition present in one of the overflow registers 502(1)-502(3). A network congestion state 510 can either be congested or not congested in this example. If the network congestion state 510 indicated by the network congestion signal 508 is a congested state, this means that the multiplexer circuit 504 will not provide the telemetry data 118P, 118M, 118L stored in a holding register 500(1)-500(3) to the packet builder circuit 512. In this manner, a telemetry data packet 124P, 124M, 124L is not built and transmitted in response to the internal communication network 106 being in a congested state.

Newly received telemetry data 118P, 118M, 118L is always written to the respective corresponding holding registers 500(1)-500(3). Thus, if any of the respective holding registers 500(1)-500(3) contain existing telemetry data 118P, 118M, 118L not yet output to be packetized and transmitted on the utility network 106(2) when respective new telemetry data 118P, 118M, 118L is received, such existing stored telemetry data 118P, 118M, 118L will be lost by being overwritten. Once the network congestion state 510 of the internal communication network 106 returns to a non-congested state, the multiplexer circuit 504 can continue to provide the respective existing telemetry data 118P, 118M, 118L stored in the corresponding holding registers 500(1)-500(3) to be transmitted as a telemetry data packet 124P, 124M, 124L on the utility network 106(2). The network congestion state 510 indicated by the network congestion signal 508 can be set by the internal communication network 106 or other circuit that is capable of determining if the throughput of the internal communication network 106 is sufficient to indicate a congested state (e.g., meaning that enough network nodes XP in the internal communication network 106 are available to arbitrate data packets) or not sufficient such that internal communication network 106 is congested.

FIG. 5B is a block diagram of exemplary details of another portion of the telemetry producer circuit 120 for receiving and transmitting received current consumption telemetry data 118C, voltage telemetry data 118V, and temperature telemetry data 118T onto the utility network 106(2). The telemetry producer circuit 120 can be any of the telemetry producer circuits 120(1)-120(N) in FIGS. 1-3. As shown in FIG. 5A, the telemetry producer circuit 120 is also configured to receive current consumption telemetry data 118C, voltage telemetry data 118V, and temperature telemetry data 118T to be transmitted as respective telemetry data packets 124C, 124V, 124T onto the utility network 106(2). The telemetry producer circuit 120 contains one or more buffer circuits 526 that are configured to individually or collectively receive the telemetry data packets 124C, 124V, 124T and provide such to one or more packet builder circuits 522 to generate the telemetry data packet 124C, 124V, 124T with the respective telemetry data 118C, 118V, 118T to be transmitted on the utility network 106(2) to be received by the telemetry consumer circuit 126 in FIG. 3. As shown in FIG. 5A current consumption telemetry data 118C, voltage telemetry data 118V, and temperature telemetry data 118T is transmitted onto utility network 106(2) when the internal communication network 106 is not in a state of congestion, otherwise the respective voltage telemetry data 118V, and temperature telemetry data 118T is dropped. As discussed in more detail below, the telemetry consumer circuit 126 is configured to manage tracking of timely receipt of consumption telemetry data 118C, voltage telemetry data 118V, and temperature telemetry data 118T from the utility network 106(2) for a given synchronous epoch.

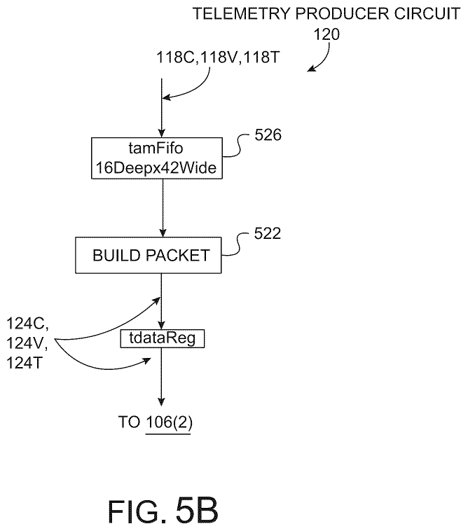

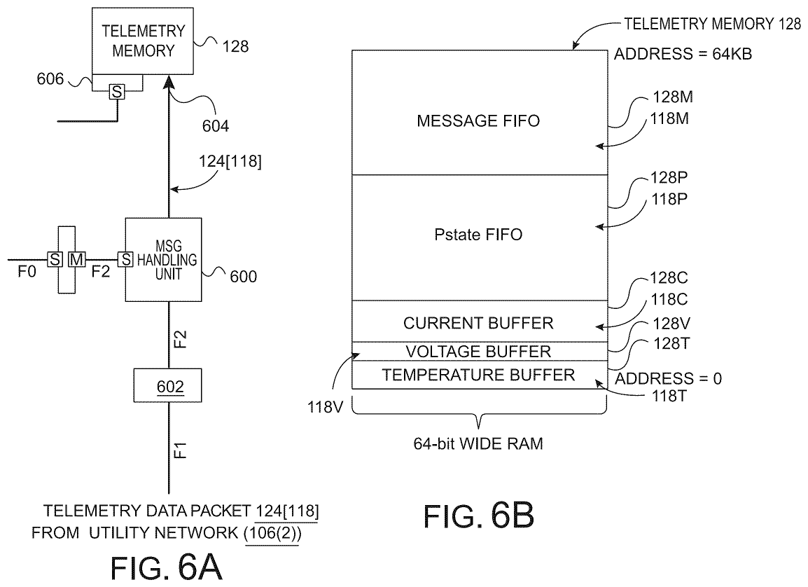

FIG. 6A is a block diagram of telemetry data packets 124 from the utility network 106(2) in FIGS. 4A and 4B coupled to the telemetry memory 128 in FIG. 3. As shown therein, telemetry data packets 124 may be received at a first frequency F1 of the internal communication network 106 and received by a message handling unit 600 in the telemetry consumer circuit 126 (see FIG. 1) operating at a second frequency F2. A frequency conversion circuit 602 converts the telemetry data 118 from the first frequency F1 to the second frequency F2 to interface with the message handling unit 600 for the telemetry data packet 124 to be received therein. The message handling unit 600 is configured to provide the received telemetry data packet 124 to a first memory port 604 of the telemetry memory 128 for its telemetry data 118 to be stored therein in a time-aligned organization according to their epoch. The message handling unit 600 is configured to use addressing information included in a received telemetry data packet 124 to know which address to write the telemetry data 118 in the received telemetry data packet 124 into the telemetry memory 124. The telemetry memory 128 may include other memory ports 606 to receive and read data from the telemetry memory 128 store other types of data in the telemetry memory 128, as shown in FIG. 6B.

In this regard, FIG. 6B is a block diagram of an exemplary organization of the telemetry memory 128 in the telemetry data system 122 in FIGS. 1 and 3 by telemetry data type. For example, the telemetry memory 128 may be a 64 KB random access memory (RAM) with 64-bit data width for example. As shown in FIG. 6B, the telemetry memory 128 can be partitioned into a temperature buffer 128T configured to store temperature telemetry data 118T, a voltage buffer 128V to store voltage telemetry data 118V, a current consumption buffer 128C to store current consumption telemetry data 118C, a performance state buffer 128P to store performance state telemetry data 118P, and a message buffer 128M to store message telemetry data 118M. As discussed above, the temperature telemetry data 118T, voltage telemetry data 118V, and current consumption telemetry data 118C are collected synchronously and provided to the telemetry producer circuits 120(1)-120(N) (see FIG. 2), whereas the performance state telemetry data 118P and message telemetry data 118M are collected and provided asynchronously. Thus, the temperature telemetry data 118T, voltage telemetry data 118V, and current consumption telemetry data 118C will be controlled to be stored time aligned for the epoch corresponding to the epoch in which the telemetry data 118T, 118V, 118C was received by the telemetry consumer circuit 126. This is so, for example, that such telemetry data 118 can be later accessed by a separate processor to analyze the telemetry data collected in the same time period and thus corresponding to the same epoch in the telemetry consumer circuit 126 to control performance parameter(s) of the processor-based system 100. The buffers in the telemetry memory 128 can be partitioned to any size desired depending on the tradeoff in the expected volume of telemetry data versus the size of the telemetry memory 128.

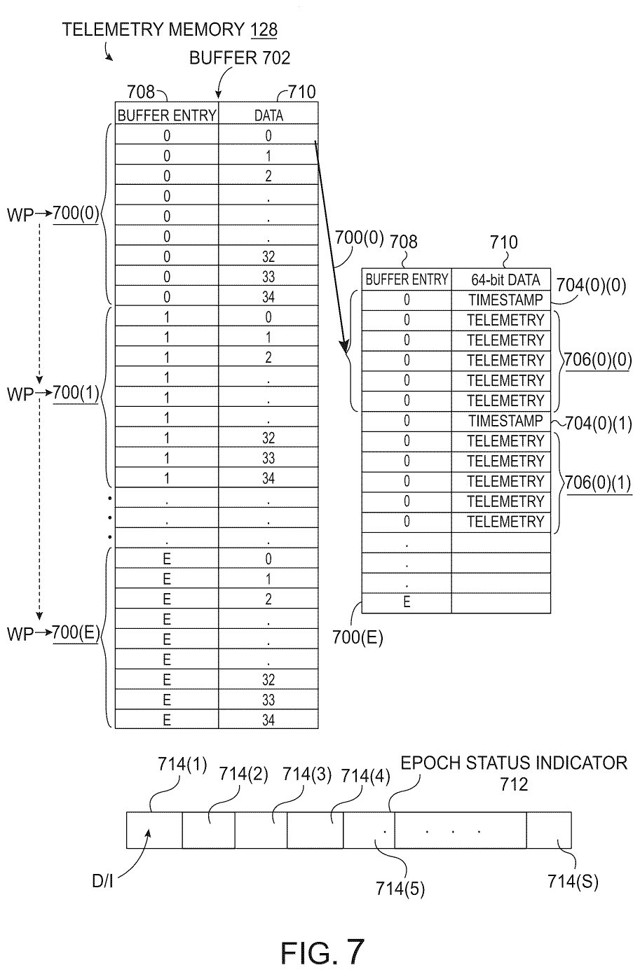

FIG. 7 is a block diagram of an exemplary organization of entries 700(0)-700(E) that can be provided in a buffer 702 in the telemetry memory 128 in FIG. 6B for storing time-aligned telemetry data 118. Each buffer entry 700(0)-700(E) is assigned for storing telemetry data 118 from multiple received telemetry data packets 124 containing the telemetry data 118 for the same epoch. Note that the buffer 702 shown in FIG. 7 can be any of the buffers 128T, 128V, 128C in FIG. 6B. As shown in FIG. 7, in this example, each buffer entry 700(0)-700(E) in the buffer 702 is configured to store telemetry data 118 for the cores 104(1)-104(N). Using buffer entry 700(0) as an example, the buffer entry 700(0) includes telemetry entries 704(0)(0), 704(0)(1) for a time stamp for each core 104(1)-104(N) of temperature data according to a given epoch in which the telemetry data 118 for the buffer entry 700(0) was received by the telemetry consumer circuit 126. Using temperature buffer entry 700(0) as an example, the temperature buffer entry 700(0) also includes telemetry entries 706(0)(0), 706(0)(1) for each core 104(1)-104(N) for the storage of the actual telemetry data 118 collected and/or received by the respective telemetry producer circuits 120(1)-120(N). Each telemetry entry 706(0)(0), 706(0)(1) maps to an addressable memory location 708 in the telemetry memory 128 and a telemetry data entry 710 for storing temperature telemetry data. The telemetry consumer circuit 126 includes a write pointer WP that is used by the telemetry consumer circuit 126 to track whether a buffer entry 700(0)-700(E) in the telemetry memory 128 has complete telemetry data 118(1)-118(N) for each of the cores 104(1)-104(N) for a given epoch. As shown in FIG. 7, the write WP is advanced to a next buffer entry 700(1)-700(E) for each epoch as discussed in more detail below. If the telemetry memory 128 includes multiple buffers 702 like the buffers 128T, 128V, 128C shown in FIG. 6B, one write pointer WP is maintained for each buffer 702 to track receipt of telemetry data 118(1)-118(N) as either complete or incomplete for each of the cores 104(1)-104(N) (and/or their tiles) for a current epoch. As telemetry data 118(1)-118(N) is determined to have been received for a given current epoch as complete, the write pointer WP is advanced to a next buffer entry 700(0)-700(E) corresponding to the next epoch to be tracked for whether telemetry data 118(1)-118(N) is complete or incomplete for a given epoch.

In this manner, the telemetry data 118 relating to the cores 104(1)-104(N) is stored time-aligned based on the given epoch in which the telemetry data 118 was collected in the telemetry consumer circuit 126. In this manner, a processor, such as control processor 331 in FIG. 3 or management processor 130 in FIG. 1, can access a buffer entry 700(0)-700(E) in the telemetry memory 128 to obtain telemetry data 118 collected by the cores 104(1)-104(N) all known to have been received in the same epoch to be analyzed for determining any changes needed or desired to performance parameter(s) in the processor-based system 100. As discussed in more detail below, the telemetry consumer circuit 126 in FIG. 3 is configured to ensure that the telemetry data 118 recorded in a given buffer entry 700(0)-700(E) in the telemetry memory 128 for a given epoch is complete, so that incomplete data is not used for a given epoch to determine any changes needed or desired to performance parameter(s) in the processor-based system 100. As also discussed in more detail below, if the telemetry consumer circuit 126 determines that all expected telemetry data 118 was not received and thus is missing for a given current epoch, the telemetry consumer circuit 126 is configured to record this as an epoch status for the current epoch as incomplete so that the buffer entry 700(0)-700(E) may not be used to analyze telemetry data 118 for controlling performance parameters of the processor-based system 100 with incomplete telemetry data 118. If the telemetry consumer circuit 126 determines all expected telemetry data 118 was received for a given current epoch, the telemetry consumer circuit 126 is configured to record this as an epoch status for the current epoch as complete or done, so that the buffer entry 700(0)-700(E) can be used to analyze telemetry data 118 for controlling performance parameters of the processor-based system 100.

Also, FIG. 7 illustrates an exemplary epoch status indicator 712 that is provided in the processor-based system 100 and is configured to be updated by the telemetry consumer circuit 126 with the epoch status for the epoch in which the telemetry data 118(1)-118(N) is received. This is so that for example, the control processor 331 in FIG. 3 can use this data to determine if telemetry data 118(1)-118(N) stored in the telemetry memory 128 is complete for a given epoch to determine if such telemetry data 118(1)-118(N) is complete and should be used to control a performance parameter(s) for a core 104(1)-104(N) in the processor-based system 100. As shown in FIG. 7, the epoch status indicator 712 may be a register. The epoch status indicator 712 contains a plurality of epoch status entries 714(1)-714(S) that are each configured to store an epoch status as either done/complete (D) or incomplete (I) based on the tracking of receipt of complete or incomplete telemetry data 118(1)-118(N) for a current epoch as discussed below. In this manner, as the telemetry consumer circuit 126 receives telemetry data packets 124(1)-124(N) for a given epoch, the telemetry consumer circuit 126 can update a corresponding epoch status entry 714(1)-714(S) in the epoch status indicator 712 indicating if all the expected telemetry data 118(1)-118(N) for a given, current epoch was received (i.e., a complete epoch status) or not received (i.e., an incomplete epoch status).

FIG. 8 is a timing diagram 800 illustrating the creation/generation of epochs to support tracking receipt of telemetry data 118(1)-118(N) within expected epochs. In this regard, as shown in FIG. 8, a periodic, synchronous, epoch expiration timer signal 802 is received by the telemetry consumer circuit 126 that is generated by an epoch expiration timer circuit 219. The epoch expiration timer signal 802 triggers the start of an epoch expiration timer 218 that defines a sample time window SW to receive telemetry data packets 124 before the next epoch expiration timer signal 802. The epoch expiration timer signal 802 also indicates the start of a next epoch (e.g., Epoch n, Epoch n+1, Epoch n+2, etc.). An epoch is defined as the time that is expected to take for the telemetry data 118(1)-118(N) collected for all the cores 104(1)-104(N) (or their tiles depending on the type of telemetry data) to be transmitted through the telemetry data system 122 and stored in the telemetry memory 128. This is shown in FIG. 8, where each epoch (e.g., Epoch n, Epoch n+1, Epoch n+2, etc.) is defined by an epoch time window TW defined by the time between the epoch expiration timer signal 802 defining the start of the epoch expiration timer 218 and a respective epoch expiration indicator 804 indicating the expected time after the epoch expiration timer signal 802 for the telemetry data 118(1)-118(N) collected for all the cores 104(1)-104(N) (and/or their tiles) to be transmitted through the telemetry data system 122 without the presence of network congestion. Thus, the epoch expiration indicator 804 indicates the normal, expected outside arrival time of all telemetry data 118(1)-118(N) for the cores 104(1)-104(N) without network congestion. As discussed in more detail below, the defining of these epochs by the epoch time windows TW is used by the telemetry consumer circuit 126 to track the receipt of telemetry data 118(1)-118(N) in each epoch as either complete or incomplete.

Also as shown in FIG. 8, the timing diagram 800 illustrates an epoch expiration buffer timer 806 that is started in response to each epoch expiration timer signal 802. The epoch expiration buffer timer 806 is used to define an epoch buffer window BW based by an expiration time 810 after each epoch expiration timer signal 802 that, in this example, is longer in duration than an epoch defined by an epoch time window TW. In this manner, if desired, the telemetry consumer circuit 126 can use the epoch buffer window BW to define an outside overhead time in which received telemetry data 118(1)-118(N) may still be received outside an epoch (i.e., after the epoch time window TW), but such received telemetry data 118(1)-118(N) still be counted towards a complete status for the current epoch. The epoch expiration buffer timer 806 is used to provide an extra, margin buffer time to account for variation in network congestion in the internal communication network 106, where it is still desired to consider telemetry data 118(1)-118(N) received within a current epoch if received before the expiration of the epoch expiration buffer timer 806.

If all expected telemetry data 118(1)-118(N) is received for a current epoch (i.e., within the epoch time window TW for the current epoch, or before expiration of the epoch expiration buffer timer 806), the telemetry consumer circuit 126 is configured to record a complete status for the epoch in the epoch status indicator 712 (see FIG. 7 above). In an example, the message handling unit 600 in the telemetry consumer circuit 126 in FIG. 6 monitors a buffer entry in the telemetry memory 128 that is currently pointed to by the write pointer WP identifying the buffer entry in the telemetry memory 128 for a current epoch. The write pointer WP is used to determine if the received telemetry data 118(1)-118(N) was received complete (i.e., received for all cores 104(1)-104(N) and/or their tiles) or incomplete for a given epoch based on tracking the telemetry data 118(1)-118(N) stored in the telemetry memory 128 in the buffer entry corresponding to the write pointer WP. The write pointer WP is advanced to point to a next buffer entry in the telemetry memory 128 in which to track receipt of telemetry data 118(1)-118(N) for a next epoch in response to an epoch that is determined to be complete. If the epoch expiration buffer timer 806 expires before complete telemetry data 118(1)-118(N) for a current epoch is received in the buffer entry corresponding to the write pointer WP in the telemetry memory 128, the expiration of the epoch expiration buffer timer 806 still causes (via the message handling unit 600 in FIG. 6) the write pointer WP to advance a next buffer entry in the telemetry memory 128 in which to track receipt of telemetry data 118(1)-118(N) for a next epoch. The write pointer WP is advanced to a next buffer entry in the telemetry memory 128 for a next epoch (i.e., a next buffer entry in telemetry memory 128 corresponding to the next epoch) upon expiration of the epoch expiration buffer timer 806 regardless of whether the telemetry data 118(1)-118(N) for the current epoch was complete. The telemetry consumer circuit 126 uses the write pointer WP to track receipt of complete telemetry data 118(1)-118(N) for the next epoch according to the buffer entry for the next epoch according to the advanced write pointer WP.

With continuing reference to FIG. 8, if it is determined that telemetry data 118(1)-118(N) for a current epoch (as tracked by the write pointer WP) is received after expiration of the epoch expiration buffer timer 806, the current epoch is indicated as incomplete by the telemetry consumer circuit 126 (e.g., by the message handling unit 600) in the epoch indicator status 712 (see FIG. 7). However, the telemetry data 118(1)-118(N) received after expiration of the epoch expiration buffer timer 806 is still written to telemetry memory 128 according to its addressing.

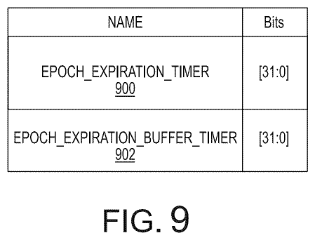

FIG. 9 is a block diagram illustrating the epoch expiration buffer timer 218 and epoch expiration buffer timer 806 implemented in respective registers 900, 902. The register 900, 902 can be used to start a timer count to implement the respective epoch expiration timer 218 and epoch expiration buffer timer 806 and their respective expirations. For example, as shown in FIG. 9, the registers 900, 902 may be configured store counters up to 32-bits ([31:0] bits).

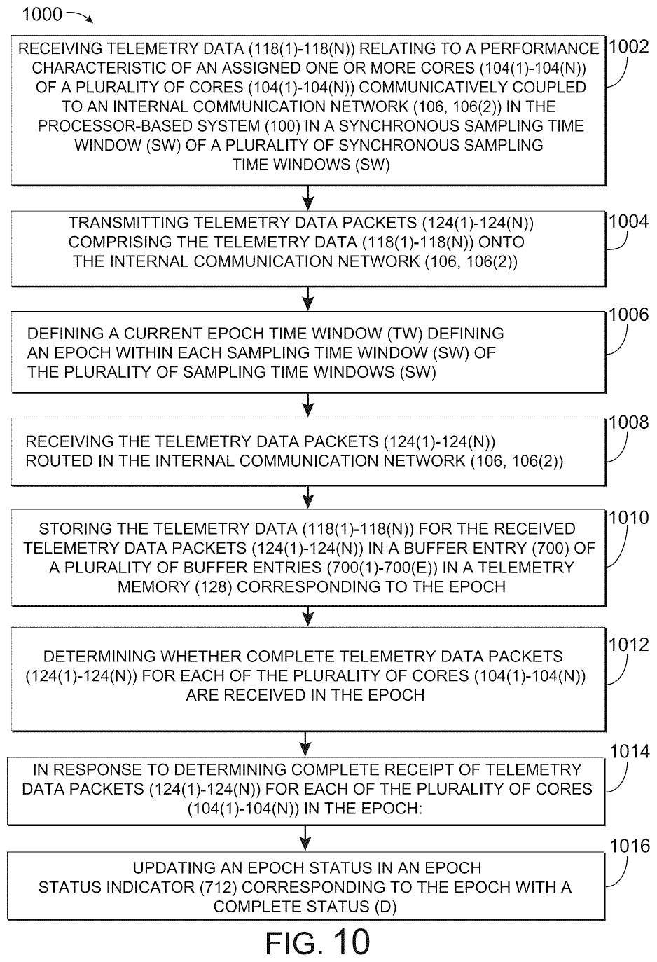

FIG. 10 is a flowchart illustrating an exemplary process 1000 of the telemetry data system 122 in the processor-based system 100 in FIGS. 1 and 3 tracking receipt of telemetry data 118(1)-118(N) stored in the telemetry memory 128 relating to performance characteristics of the cores 104(1)-104(N) within an epoch, to facilitate indicating if complete telemetry data 118(1)-118(N) was received for the epoch. The process 1000 in FIG. 10 is described in regard to the processor-based system 100 in FIGS. 1 and 3, and the telemetry memory 128 in FIG. 7 and timing diagram in FIG. 8, and as described above.

In this regard, a first step in the process 1000 can be to receiving telemetry data 118(1)-118(N) relating to a performance characteristic of an assigned one or more cores 104(1)-104(N) of a plurality of cores 104(1)-104(N) communicatively coupled to an internal communication network 106, 106(2) in the processor-based system 100 in a synchronous sampling time window SW of a plurality of synchronous sampling time windows SW (block 1002 in FIG. 10). A next step in the process 1000 can be transmitting telemetry data packets 124(1)-124(N) comprising the telemetry data 118(1)-118(N) onto the internal communication network 106, 106(2) (block 1004 in FIG. 10). A next step in the process 1000 can be defining a current epoch time window TW defining an epoch within each sampling time window SW of the plurality of sampling time windows SW (block 1006 in FIG. 10). A next step in the process 1000 can be receiving the telemetry data packets 124(1)-124(N) routed in the internal communication network 106, 106(2) (block 1008 in FIG. 10). A next step in the process 1000 can be storing the telemetry data 118(1)-118(N) for the received telemetry data packets 124(1)-124(N) in a buffer entry 700 of a plurality of buffer entries 700(1)-700(E) in a telemetry memory 128 corresponding to the epoch (block 1010 in FIG. 10). A next step in the process 1000 can be determining whether complete telemetry data packets 124(1)-124(N) for each of the plurality of cores 104(1)-104(N) are received in the epoch (block 1012 in FIG. 10). In response to determining complete receipt of telemetry data packets 124(1)-124(N) for each of the plurality of cores 104(1)-104(N) in the epoch (block 1014 in FIG. 10), a next step in the process 1000 can be updating an epoch status in an epoch status indicator 712 corresponding to the epoch with a complete status D (block 1016 in FIG. 10).

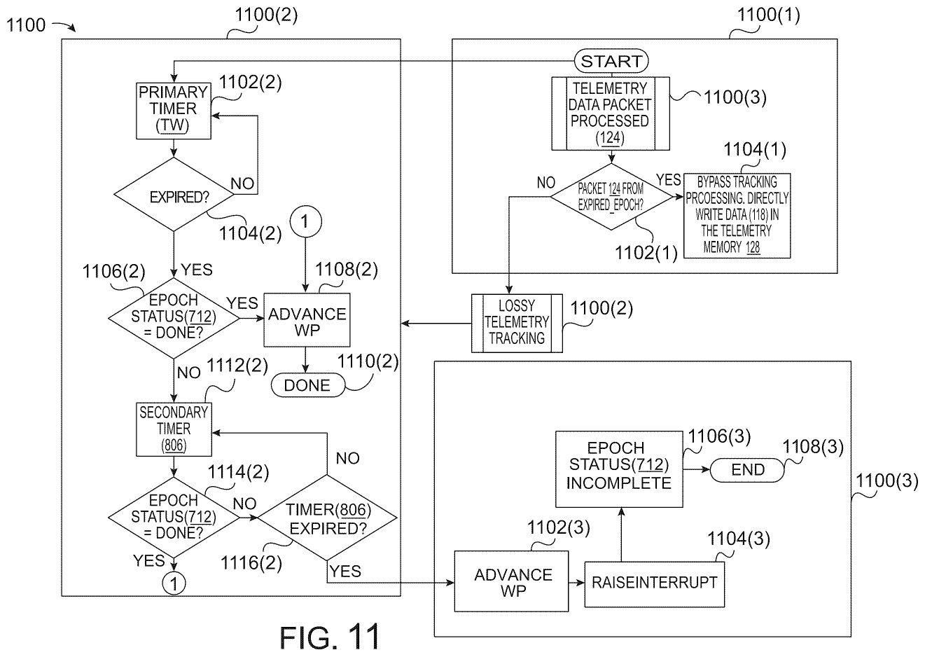

Other processes can be performed by the telemetry data system 122 and its circuits to track receipt of telemetry data 118(1)-118(N) within a given epoch and manage time alignment of complete telemetry data 118(1)-118(N) in the telemetry memory 128 relating to performance characteristics of the cores 104(1)-104(N) received in the same epoch. In this regard, FIG. 11 is a diagram illustrating an exemplary process 1100 that can be performed by the telemetry consumer circuit 126 in FIG. 3, for tracking receipt of telemetry data 118(1)-118(N) within a given epoch in the telemetry memory 128 relating to performance characteristics of the cores 104(1)-104(N) collected in the same epoch. The process 1100 in FIG. 11 uses both the epoch time window TW and epoch expiration buffer timer 806 in FIG. 8 to tracking receipt of telemetry data 118(1)-118(N) within a given epoch in the telemetry memory 128 relating to performance characteristics of the cores 104(1)-104(N) collected in the same epoch. The exemplary process 1100 in this example includes three (3) separate processes 1100(1)-1100(3) as will now be described.

In this regard, as shown in FIG. 11, a first process 1100(1) that can be performed by the telemetry consumer circuit 126 is a main process 1100(1) involved with receiving telemetry data packets 124(1)-124(N) from the internal communication network 106 and causing the telemetry data 118(1)-118(N) within the received telemetry data packets 124(1)-124(N) to be processed. The process 1100(1) involves the telemetry consumer circuit 126 determining if a received telemetry data packet 124 is received from an expired epoch (i.e., after the expiration of the epoch expiration buffer timer 806 for the current epoch in FIG. 8) (block 1102(1) in main process 1100(1) in FIG. 11). If so, the telemetry data 118 for the received telemetry data packet 124 outside of the epoch after the expiration of the epoch expiration buffer timer 806 is still written to a buffer entry 700(0)-700(E) according to the addressing in the telemetry data packet 124 in the telemetry memory 128 (block 1104(1) in main process 1100(1) in FIG. 11). If not, the telemetry consumer circuit 126 is configured to perform a lossy telemetry tracking process 1100(2) as shown in FIG. 11 to determine if all the expected telemetry data packets 124(1)-124(N) for the cores 104(1)-104(N) for a given current epoch were received within or outside of the epoch.

In the lossy telemetry tracking process 1100(2) in FIG. 11, the expiration of the epoch time window TW according to epoch expiration indicator 804 in FIG. 8 and the expiration of epoch expiration buffer timer 806 are used to determine if telemetry data 118 expected to be received within the current epoch is received with the epoch. In this regard, as shown in FIG. 11, in the lossy telemetry tracking process 1100(2), the epoch time window TW is started based on the epoch expiration timer signal 802 (block 1102(2) in process 1100(2) in FIG. 11). In response to the epoch expiring according to the epoch expiration indicator 804 (block 1104(2) in process 1100(2) in FIG. 11), the telemetry consumer circuit 126 determines if the epoch status for the current epoch is done or complete, based on tracking the telemetry data 118(1)-118(N) stored in the telemetry memory 128 in a buffer entry 700 pointed to by the write pointer WP (block 1106(2) in process 1100(2) in FIG. 11). If so, the write pointer AP is advanced to the next buffer entry in telemetry memory 128 for the next epoch (block 1108(2) in process 1100(2), and the lossy telemetry tracking process 1100(2) ends (block 1110(2) in process 1100(2) in FIG. 11), because this means that all expected telemetry data packets 124(1)-124(N) for a given current epoch were timely received.

If telemetry consumer circuit 126 determines if the epoch status for the current epoch is done or complete (i.e., the “NO” path) (block 1106(2) in process 1100(2)), the epoch expiration buffer timer 806 is used to extend the time for receiving complete telemetry data 118(1)-118(N) in the current epoch (block 1112(2) in process 1100(2) in FIG. 11). The telemetry consumer circuit 126 determines if the epoch status for the current epoch is done or complete based on receiving telemetry data 118(1)-118(N) before the expiration of the epoch expiration buffer timer 806 (block 1114(2) in process 1100(2) in FIG. 11). If the epoch status for the current epoch is done (i.e., complete), the write pointer WP is advanced to the next buffer entry for the next epoch in telemetry memory 128 (block 1108(2) in process 1100(2)), and process ends (block 1110(2) in process 1100(2) in FIG. 11). If the epoch expiration buffer timer 806 expires before the epoch status for the current epoch is done (i.e., complete) (block 1116(2) in process 1100(2) in FIG. 11), the telemetry incomplete handling process 1100(3) is performed. The write pointer WP is advanced to the next epoch, and an interrupt is generated (block 1104(3) in process 1100(3)) to update the epoch indicator status 712 for the epoch is as incomplete 1104 (block 1106(3) in process 1100(3)), and the process ends (block 1108(3) in process 1100(3)).

In this manner, the epoch status in the epoch status indicator 712 is kept updated to indicate whether complete telemetry data 118(1)-118(N) was received for each epoch. This allows the control processor 331 in FIG. 3 to determine if telemetry data 118(1)-118(N) for a given epoch is complete. The control processor 331 can choose to not use incomplete telemetry data 118(1)-118(N) for a given epoch to be used to control performance parameters of the cores 104(1)-104(N) in the processor-based system 100.

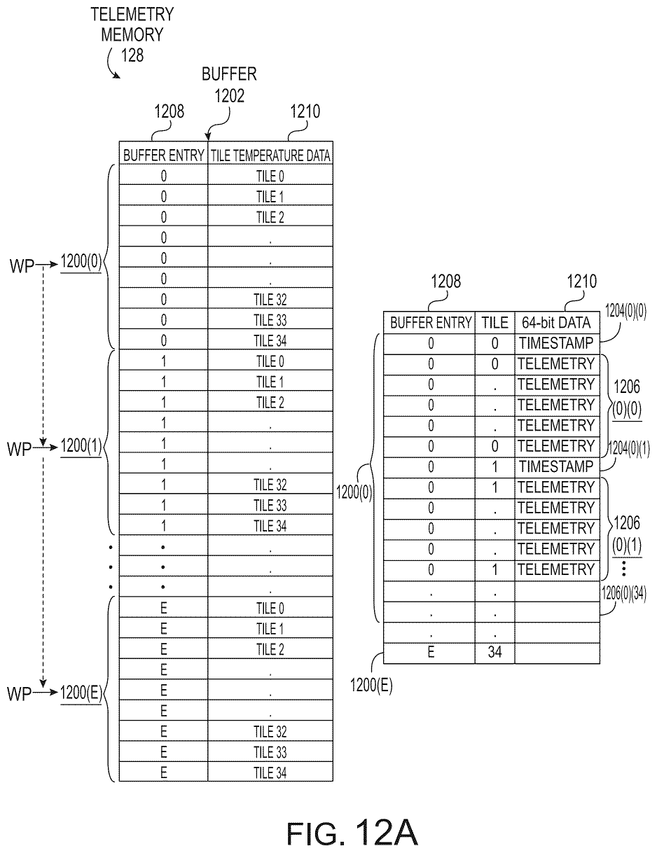

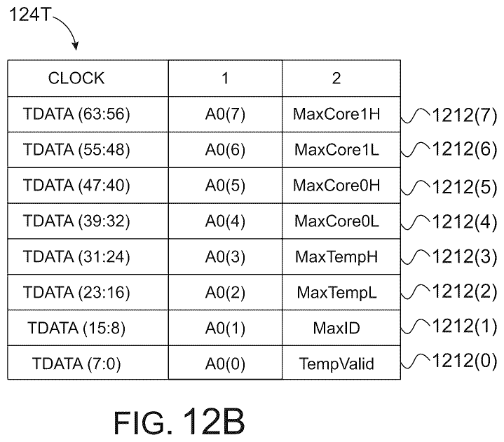

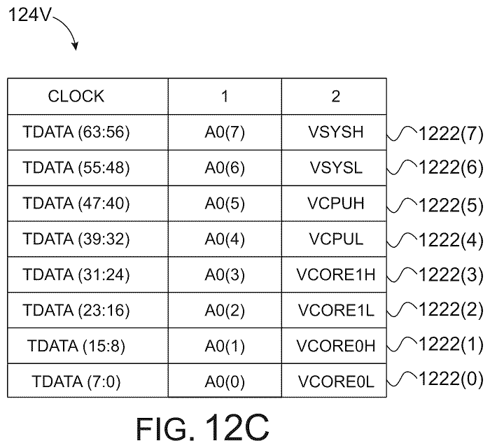

As discussed above in respect to FIG. 3, there are different types of telemetry data 118(1)-118(N) that can be collected and provided to the telemetry producer circuits 120(1)-120(N) to be transmitted in respective telemetry data packets 124(1)-124(N). For example, FIG. 12A is a block diagram of an exemplary organization of tile entries 1200(0)-1200(E) that can be provided in a buffer 1202 in the telemetry memory 128 for storing time-aligned tile telemetry data 118(1)-118(N/2) for cores 104(1)-104(N) organized as tiles. The title telemetry data is N/2 for N number of cores 104(1)-104(N) in this example, because each tile represents a set consisting of two (2) of the cores 104(1)-104(N). For example, the buffer 1202 in FIG. 12A could be used to store temperature telemetry data 118T or voltage telemetry data 118V collected on a per core 104(1)-104(N) tile basis. Each tile buffer entry 1200(0)-1200(E) is assigned for telemetry data 118(1)-118(N) from multiple received tile telemetry data packets 124(1)-124(N) containing the respective tile telemetry data 118(1)-118(N) from the same epoch for all core tiles.

As shown in FIG. 12A, in this example, each tile buffer entry 1200(0)-1200(E) in the buffer 1202 is configured to store tile telemetry data 118 for the core tiles on a per tile basis (e.g., Tile 0, Tile 1, . . . , Tile 34) for a respective epoch 0-E. Using tile buffer entry 1200(0) as an example, the tile buffer entry 1200(0) includes a tile sub-entry 1206(0)(0)-1206(0)(34) for each respective core tile for Tiles 0-34 in this example. For example, tile sub-entry 1206(0)(0) is for Tile 0 in tile buffer entry 1200(0), tile sub-entry 1206(0)(1) is for Tile 1 in tile buffer entry 1200(0), and so on to tile sub-entry 1206(0)(34) for Tile 34. Using tile buffer entry 1200(0) as an example, the tile buffer entry 1200(0) includes time stamps 1204(0)(0)-1204(0)(34) for the respective core tiles Tiles 0-34 for storing time stamp data in which the tile telemetry data 118 for a given core tile was received. Also using tile buffer entry 1200(0) as an example, the tile buffer entry 1200(0) also includes tile sub-entries 1206(0)(0) 1206(0)(34) for respective core tiles Tiles 0-34 for the storage of the actual tile telemetry data 118 for each respective core tile. Each tile telemetry entry 1206(0)(0) 1206(0)(34) maps to an addressable memory location 1208 in the telemetry memory 128 and a telemetry data entry 1210 for storing tile telemetry data. Note that although tile buffer entry 1200(0) was referenced as the example, the above discussion also applies to the other tile buffer entries 1200(1)-1200(E) for storing tile telemetry data 118 corresponding to other epochs.

The telemetry consumer circuit 126 includes a write pointer WP that is used to point to a next tile buffer entry 1200(0)-1200(E) in the telemetry memory 128 to be tracked to determine if all telemetry data 118(1)-118(N) for all core tiles for a given epoch was received as complete or incomplete. Once complete tile telemetry data 118(1)-118(N) is received for a given current epoch time or the epoch expiration buffer timer 806 has expired, the write pointer WP is advanced to a next tile buffer entry 1200(0)-1200(E) to be tracked for a next epoch.

In this manner, the telemetry data 118 from cores 104(1)-104(N) is stored time-aligned for a given epoch corresponding to an epoch in which the tile telemetry data 118 was received. In this manner, a control processor, such as control processor 331 in FIG. 3, can access a tile buffer entry 1200(0)-1200(E) in the telemetry memory 128 to obtain tile telemetry data 118 collected by the cores 104(1)-104(N) all known to have been collected in the same epoch to be analyzed for determining any changes needed or desired to performance parameter(s) in the processor-based system 100. As discussed above, the telemetry consumer circuit 126 in FIG. 3 is configured to ensure that the tile telemetry data 118 recorded in a given tile buffer entry 1200(0)-1200(E) in the telemetry memory 128 is complete, so that incompletely received data is not used for a given epoch in the processor-based system 100 to determine any changes needed or desired to performance parameter(s) in the processor-based system 100. As also discussed in more detail below, if the telemetry consumer circuit 126 determines that all expected tile telemetry data 118 was not received and thus is missing for a given current epoch, the telemetry consumer circuit 126 is configured to record this as an epoch status for the epoch corresponding to the current epoch as incomplete so that the tile buffer entry 1200(0)-1200(E) is not used by the control processor 331 to analyze tile telemetry data 118 for controlling performance parameters of the processor-based system 100. If the telemetry consumer circuit 126 determines all expected tile telemetry data 118 was received for a given current epoch, the telemetry consumer circuit 126 is configured to record this as an epoch status for the epoch corresponding to the current epoch as complete or done, so that the tile buffer entry 1200(0)-1200(E) can be used by the control processor 331 to analyze tile telemetry data 118 for controlling performance parameters of the processor-based system 100.

FIG. 12B illustrates an exemplary data format for a temperature telemetry data packet 124T which was produced in the processor-based system 100 in FIGS. 1-3 and can be stored in a buffer in the telemetry memory 128 like the buffer 1202 in FIG. 12A. The temperature telemetry data packet 124T includes a 64-bit telemetry data word that is split into eight (8) temperature telemetry data words 1212(0)-1212(7). Temperature telemetry data word 1212(0) is configured to store a temperature valid indicator TempValid indicating the format of the temperature telemetry data packet 124T. TempValid=0 implies the format shown. TempValid=1 implies 2 additional 64-bit data beats will be transmitted with the values for all eight (8) temperature sensors. Temperature telemetry data word 1212(1) is configured to store a maximum ID MaxID identifying ID of the temperature sensor with the maximum temperature value in the core 104(1)-104(N) tile. Temperature telemetry data words 1212(2), 1212(3) are configured to store a maximum temperature as a data word with the lower bits of the maximum temperature as MaxTempL and the higher bits of the maximum temperature as MaxTempH for the overall core 104(1)-104(N) tile. Temperature telemetry data words 1212(4), 1212(5) are configured to store a core 0 maximum temperature as a data word with the lower bits of the maximum temperature MaxCore0L and with the higher bits of the maximum temperature as MaxCore0H for a core 0 104(1)-104(N) in the core 104(1)-104(N) tile. Temperature telemetry data words 1212(6), 1212(7) are configured to store a maximum temperature as a data word with the lower bits of the maximum temperature as MaxCore1L and with the higher bits of the maximum temperature as MaxCore1H for a core 1 104(1)-104(N) in the core 104(1)-104(N) tile.

FIG. 12C illustrates an exemplary data format for a voltage telemetry data packet 124V which was produced in the processor-based system 100 in FIGS. 1-3 and can be stored in a buffer in the telemetry memory 128 like the buffer 1202 in FIG. 12A. The voltage telemetry data packet 124V includes a 64-bit telemetry data word that is split into eight (8) voltage telemetry data words 1222(0)-1222(7). Voltage telemetry data words 1222(0), 1222(1) are configured to store voltage as a data word with lower bits of the voltage VCORE0L and with the higher bits of the voltage as VORE0H for a core 0 104(1)-104(N) in the core 104(1)-104(N) tile. Voltage telemetry data words 1222(2), 1222(3) are configured to store a voltage as a data word with the lower bits of the voltage as VCORE1L and the higher bits of the voltage as VCORE1H for a core 1 104(1)-104(N) in the core 104(1)-104(N) tile. Voltage telemetry data words 1222(4), 1222(5) are configured to store an overall CPU/core voltage as a data words with lower bits of the voltage as VCPUL and the higher bits of the voltage as VCPUH in a core 104(1)-104(N) tile. Voltage telemetry data words 1222(6), 1222(7) are configured to store voltage as a data word with the lower bits of the voltage as VSYSL and the higher bits of the voltage as VSYSH in a core 104(1)-104(N) tile.

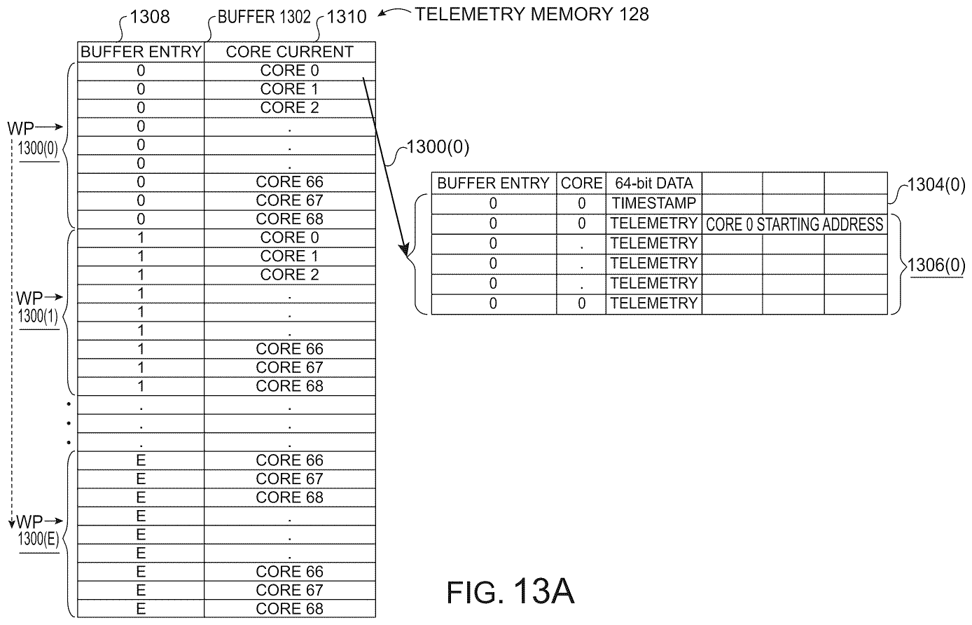

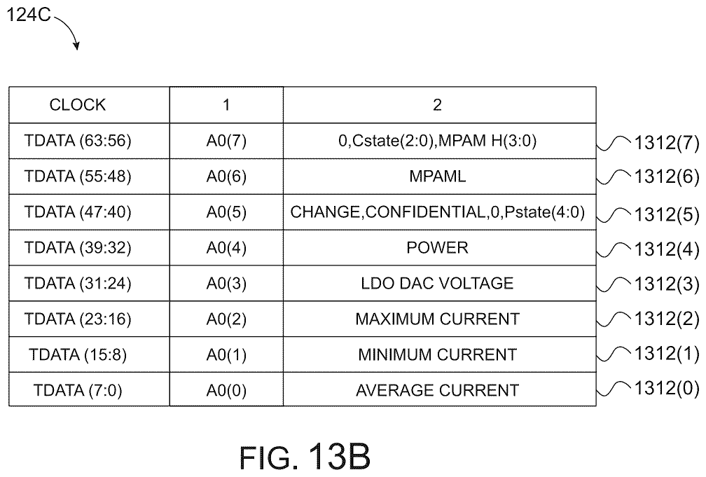

FIG. 13A is a block diagram of an exemplary organization of entries 1300(0)-1300(E) that can be provided in a buffer 1302 in the telemetry memory 128 for storing time-aligned telemetry data 118(1)-118(N) for cores 104(1)-104(N) that is organized per core and not per core tile. For example, the buffer 1302 in FIG. 13A could be used to store current consumption telemetry data 118C collected on a per core 104(1)-104(N) basis. Each buffer entry 1300(0)-1300(E) is assigned for telemetry data 118(1)-118(N) from multiple received telemetry data packets 124(1)-124(N) containing the respective telemetry data 118(1)-118(N) for the epoch received in the same epoch. As shown in FIG. 13A, in this example, each buffer entry 1300(0)-1300(E) in the buffer 1302 is configured to store telemetry data 118 for each core 104(1)-104(N) on a per core basis. Using buffer entry 1300(0) as an example, the buffer entry 1300(0) includes a telemetry time stamp 1304(0) for a time stamp for each core 104(1)-104(N) of telemetry data 118(1)-118(N) according to a given epoch in which the telemetry data 118 for the buffer entry 1300(0) was received. Also using buffer entry 1300(0) as an example, the buffer entry 1300(0) also includes telemetry data entries 1306(0) for each core 104(1)-104(N) for the storage of the actual telemetry data 118 relating to the respective the cores 104(1)-104(N) for buffer entry 1300(0). Each telemetry data entry 1306(0) maps to an addressable memory location 1308 in the telemetry memory 128 and a data entry 1310 for storing telemetry data.

The telemetry consumer circuit 126 also includes a write pointer WP that is used to point to a next buffer entry 1300(0)-1300(E) in the telemetry memory 128 to be tracked to determine if all telemetry data 118(1)-118(N) for all the cores 104(1)-104(N) for a given epoch was received as complete or incomplete Once complete telemetry data 118(1)-118(N) is received for a given current epoch time or the epoch expiration buffer timer 806 has expired, the write pointer WP is advanced to a next buffer entry 1300(0)-1300(E) to be tracked for a next epoch.

In this manner, the telemetry data 118 for the cores 104(1)-104(N) is stored time-aligned in epochs based on the given epoch in which the telemetry data 118 was received. In this manner, a control processor, such as control processor 331 in FIG. 1, can access a buffer entry 1300(0)-1300(E) in the telemetry memory 128 to obtain telemetry data 118 collected by the cores 104(1)-104(N) all known to have been collected in the same synchronous, sampling time window to be analyzed for determining any changes needed or desired to performance parameter(s) in the processor-based system 100. As discussed above, the telemetry consumer circuit 126 in FIG. 3 is configured to ensure that the telemetry data 118 recorded in a given buffer entry 1300(0)-1300(E) in the telemetry memory 128 is complete, so that incomplete data is not used for an epoch to determine any changes needed or desired to performance parameter(s) in the processor-based system 100. As also discussed in more detail below, if the telemetry consumer circuit 126 determines that all expected telemetry data 118 was not received and thus is missing for a given epoch, the telemetry consumer circuit 126 is configured to record this as an epoch status) for the epoch corresponding to the current synchronous, sampling time window as incomplete. This is so that the buffer entry 1300(0)-1300(E) is not used by the control processor 331 to analyze telemetry data 118 for controlling performance parameters of the processor-based system 100. If the telemetry consumer circuit 126 determines all expected telemetry data 118 was received for a given epoch, the telemetry consumer circuit 126 is configured to record this as an epoch status for the epoch corresponding to the current synchronous, sampling time window as complete or done, so that the buffer entry 1300(0)-1300(E) can be used by the control processor 331 to analyze telemetry data 118 for controlling performance parameters of the processor-based system 100.

FIG. 13B illustrates an exemplary data format for a current consumption telemetry data packet 124C which was produced in the processor-based system 100 in FIGS. 1-3 and can be stored in a buffer in the telemetry memory 128 like the buffer 1302 in FIG. 13A. The current consumption telemetry data packet 124C includes a 64-bit telemetry data word that is split into eight temperature telemetry data words 1312(0)-1312(7). Current consumption telemetry data word 1312(0) is configured to store an average current consumption AVERAGE CURRENT by a respective core 104(1)-104(N). Current consumption telemetry data word 1312(1) is configured to store a minimum current consumption MINIMUM CURRENT by a respective core 104(1)-104(N). Current consumption telemetry data word 1312(2) is configured to store a maximum current consumption MAXIMUM CURRENT by a respective core 104(1)-104(N). Current consumption telemetry data word 1312(3) is configured to store a local voltage level LDO DAC VOLTAGE for a respective core 104(1)-104(N). Current consumption telemetry data word 1312(4) is configured to store a power level POWER for a respective core 104(1)-104(N). Current consumption telemetry data words 1312(5)-1312(7) are configured to store other performance state information for a respective core 104(1)-104(N).

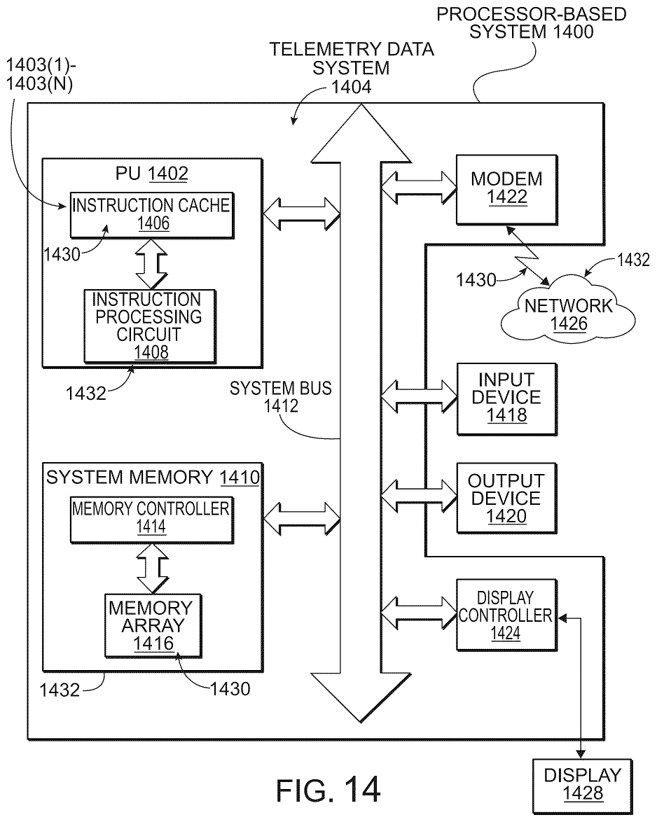

FIG. 14 is a block diagram of an exemplary processor-based system 1400 that can be the processor-based system 100 in FIGS. 1 and 3, and wherein the processor-based system 1400 includes a PU 1402 and a plurality of processor cores (“cores”) 1403(1)-1403(N) communicatively coupled to a system bus 1412 as an internal communication network, and an exemplary telemetry data system 1404 configured to track receipt of telemetry data stored in the telemetry memory 128 relating to performance characteristics of the cores 104(1)-104(N) within an epoch, to facilitate indicating if complete telemetry data 118(1)-118(N) was received for the epoch, to more accurately control performance parameters in the processor-based system to enhance performance, including according to, but not limited to, the processes 1000, 1100 in FIGS. 10 and 11, to more accurately control performance parameters in the processor-based system to enhance performance.

The processor-based system 1400 includes the PU 1402. The processor-based system 1400 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server or a user's computer. In this example, the processor-based system 1400 includes the PU 1402. The PU 1402 represents one or more general-purpose processing circuits, such as a microprocessor, central processing unit, or the like. The PU 1402 is configured to execute processing logic in computer instructions for performing the operations and steps discussed herein.

The PU 1402 also includes an instruction cache 1406 for temporary, fast access memory storage of instructions and an instruction processing circuit 1408. Fetched or prefetched instructions from a memory, such as from a system memory 1410 over the system bus 1412, are stored in the instruction cache 1406. The instruction processing circuit 1408 is configured to process instructions fetched into the instruction cache 1406 and process the instructions for execution. The instruction processing circuit 1408 is configured to insert the fetched instructions into one or more instruction pipelines that are then processed to execution.

The PU 1402 and the system memory 1410 are coupled to the system bus 1412 and can intercouple peripheral devices included in the processor-based system 1400. The system memory 1410 can be or include a RAM that provides a telemetry memory that is configured to store telemetry data in a time-aligned manner relating to the cores 1403(1)-1403(N) as controlled by the telemetry data system 1404. As is well known, the PU 1402 communicates with these other devices by exchanging address, control, and data information over the system bus 1412. For example, the PU 1402 can communicate bus transaction requests to a memory controller 1414 in the system memory 1410 as an example of a controlled device. Although not illustrated in FIG. 14, multiple system buses 1412 could be provided, wherein each system bus constitutes a different fabric. In this example, the memory controller 1414 is configured to provide memory read and/or write requests to a memory array 1416 in the system memory 1410. The memory array 1416 is comprised of an array of storage bit cells for storing data. The system memory 1410 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 1412. As illustrated in FIG. 14, these devices can include the system memory 1410, one or more input device(s) 1418, one or more output device(s) 1420, a modem 1422, and one or more display controllers 1424, as examples. The input device(s) 1418 can include any type of input device, including, but not limited to, input keys, switches, voice processors, etc. The output device(s) 1420 can include any type of output device, including, but not limited to, audio, video, other visual indicators, etc. The modem 1422 can be any device configured to allow exchange of data to and from a network 1426. The network 1426 can be any type of network, including, but not limited to, a wired or wireless network, a private or public network, a local area network (LAN), a wireless local area network (WLAN), a wide area network (WAN), a BLUETOOTH™ network, and the Internet. The modem 1422 can be configured to support any type of communications protocol desired. The PU 1402 may also be configured to access the display controller(s) 1424 over the system bus 1412 to control information sent to one or more displays 1428. The display(s) 1428 can include any type of display, including, but not limited to, a cathode ray tube (CRT), a liquid crystal display (LCD), a plasma display, etc.

The processor-based system 1400 in FIG. 14 may include a set of instructions 1430 that may be used to provide the functionality, including to control the operation of the telemetry data system 1404. The instructions 1430 may be stored in the system memory 1410, PU 1402, and/or instruction cache 1406 as examples of non-transitory computer-readable medium 1432. The instructions 1430 may also reside, completely or at least partially, within the system memory 1410 and/or within the PU 1402 during their execution. The instructions 1430 may further be transmitted or received over the network 1426 via the modem 1422, such that the network 1426 includes the non-transitory computer-readable medium 1432.

While the non-transitory computer-readable medium 1432 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (RAM), a magnetic disk storage medium, an optical storage medium, flash memory devices, etc.) and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories, registers, or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium, and executed by a processor or other processing device, or combinations of both. The components of the processors and systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be referenced throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents.

1-20. (canceled)

21. A processor-based system, comprising:
a plurality of cores;
a network configured to transmit telemetry data associated with the plurality of cores, the telemetry data being collected during a plurality of sampling time windows over time, wherein the network is an internal communication network;
a telemetry memory configured to store the telemetry data in a plurality of buffer entries, the plurality of buffer entries respectively corresponding to a plurality of epochs associated with the plurality of sampling time windows;
a telemetry consumer configured to:
for a current epoch of the plurality of epochs within a current sampling time window of the plurality of sampling time windows:
receive the telemetry data from the network;
store the telemetry data of the current epoch in a buffer entry of the plurality of buffer entries corresponding to the current epoch;
determine that, for the current epoch, complete telemetry data from each of the plurality of cores has not been received; and
in response to determining that, for the current epoch, complete telemetry data from each of the plurality of cores has not been received, update an epoch status in an epoch status indicator corresponding to the current epoch to indicate incomplete telemetry data; and
a control processor configured to control a performance parameter of the plurality of cores based on the telemetry data and the epoch status indicator corresponding to the current epoch.

22. The processor-based system of claim 21, wherein, for a subsequent epoch of the plurality of epochs, the telemetry consumer determines that complete telemetry data from each of the plurality of cores has been received for the subsequent epoch, and updates an epoch status in the epoch status indicator corresponding to the subsequent epoch with a complete status.

23. The processor-based system of claim 21, wherein the telemetry consumer is further configured to:
update a write pointer to point to the buffer entry of the plurality of buffer entries in the telemetry memory corresponding to the current epoch; and
determine that complete telemetry data from each of the plurality of cores has not been received in the current epoch, based on determining that the buffer entry of the plurality of buffer entries in the telemetry memory corresponding to the write pointer does not have complete telemetry data for each of the plurality of cores.

24. The processor-based system of claim 23, wherein the telemetry consumer is further configured to:
in response to determining that, for the current epoch, complete telemetry data from each of the plurality of cores has not been received:
update the write pointer to the next buffer entry of the plurality of buffer entries in the telemetry memory for an epoch for a next sampling time window of the plurality of sampling time windows.

25. The processor-based system of claim 21, wherein controlling the performance parameter of the plurality of cores comprises:
determining a new performance state in the processor-based system by:
determining a complete epoch of the plurality of epochs having the epoch status of complete status in the epoch status indicator;
accessing the telemetry data in the buffer entry of the plurality of buffer entries in the telemetry memory corresponding to the determined complete epoch; and
analyzing the accessed telemetry data to determine the new performance state; and
controlling a core of the plurality of cores to operate at the new performance state to control a plurality of performance parameters comprising the performance parameter, wherein the plurality of performance parameters comprises voltage and frequency.

26. The processor-based system of claim 25, wherein the control processor is configured to determine the complete epoch by being configured to:
determine a most recent complete epoch having the epoch status of the complete status in the epoch status indicator.

27. The processor-based system of claim 21, wherein determining that, for the current epoch, complete telemetry data from each of the plurality of cores has not been received and updating the epoch status comprises:
generating a current epoch buffer window that includes the current epoch and extends beyond the current epoch and is within the current sampling time window; and
determining that complete telemetry data from the plurality of cores has not been received in the current epoch buffer window.

28. The processor-based system of claim 27, wherein the telemetry consumer is further configured to:
update a write pointer to point to the buffer entry of the plurality of buffer entries in the telemetry memory corresponding to the current epoch;
determine that complete telemetry data from each of the plurality of cores has not been received in the current epoch, based on determining that the buffer entry of the plurality of buffer entries in the telemetry memory corresponding to the write pointer does not have complete telemetry data from each of the plurality of cores.

29. The processor-based system of claim 28, wherein the telemetry consumer is further configured to, in response to determining that complete telemetry data from the plurality of cores has not been received in the current epoch buffer window:
update the epoch status in the epoch status indicator corresponding to the current epoch with an incomplete status.

30. The processor-based system of claim 29, wherein the telemetry consumer is further configured to:
update a write pointer to point to the buffer entry of the plurality of buffer entries in the telemetry memory corresponding to the current epoch; and
in response to determining that complete telemetry data from each of the plurality of cores has not been received in the current epoch buffer window:
update the write pointer to a next buffer entry of the plurality of buffer entries in the telemetry memory for the current epoch.

31. The processor-based system of claim 21, wherein the telemetry consumer is configured to, in response to determining that, for the current epoch, complete telemetry data from each of the plurality of cores has not been received:
generate an interrupt indicating missing telemetry data for the current epoch; and
in response to the interrupt, update the epoch status in the epoch status indicator corresponding to the current epoch with an incomplete status.

32. The processor-based system of claim 21, wherein:
the telemetry memory comprises:
a first plurality of entries corresponding to a first type of telemetry data; and
a second plurality of entries corresponding to a second type of telemetry data;
the epoch status indicator is configured to store a plurality of epoch statuses by being configured to:
store a plurality of first epoch statuses corresponding to the first type of telemetry data for respective epochs of the plurality of epochs; and
store a plurality of second epoch statuses corresponding to the second type of telemetry data for the respective epochs of the plurality of epochs; and
the processor-based system is configured to:
receive the telemetry data by being configured to:
transmit the telemetry data onto the network;
receive first telemetry data relating to a first performance characteristic of an assigned core of the plurality of cores; and
receive second telemetry data relating to a second performance characteristic of the assigned core of the plurality of cores; and
transmit the received telemetry data by being configured to:
transmit first telemetry data packets with the first telemetry data onto the network; and
transmit second telemetry data packets with the second telemetry data onto the network.

33. The processor-based system of claim 32, wherein
the telemetry consumer is configured to:
receive the telemetry data transmitted in the network by being configured to:
receive the first telemetry data packets transmitted in the network; and
receive the second telemetry data packets transmitted in the network; and
store the telemetry data for the received telemetry data packets by being configured to, for each epoch:
store the first telemetry data for the received first telemetry data packets in the buffer entry of the plurality of buffer entries in the telemetry memory corresponding to the epoch;
store the second telemetry data for the received second telemetry data packets in the buffer entry of the plurality of buffer entries in the telemetry memory corresponding to the epoch; and
determine that complete telemetry data packets for each of the plurality of cores have not been received in the epoch by determining that complete first telemetry data packets and complete second telemetry data packets for each of the plurality of cores have not been received in the epoch.

34. The processor-based system of claim 33, wherein:
the first telemetry data is data of a first telemetry data type comprising at least one of temperature, voltage, and current consumption of the assigned core of the plurality of cores in the processor-based system; and
the second telemetry data is data of a second telemetry data type comprising at least one of temperature, voltage, and current consumption of the assigned core of the plurality of cores in the processor-based system, different from the first telemetry data type.

35. The processor-based system of claim 21, the telemetry data comprising at least one of:
an indication of temperature of an assigned core of the plurality of cores in the processor-based system;
a supply voltage of the assigned core of the plurality of cores in the processor-based system; or
a current consumption of the assigned core of the plurality of cores in the processor-based system.

36. A method, comprising:
receiving telemetry data relating to a performance characteristic of an assigned core of a plurality of cores communicatively coupled to a network during a current sampling time window, wherein the network is an internal communication network;
transmitting the telemetry data onto the network;
for a current epoch within the current sampling time window:
receiving the telemetry data from the network;
storing the telemetry data of the current epoch in a corresponding buffer entry in a telemetry memory;
determining that, for the current epoch, complete telemetry data from each of the plurality of cores has not been received; and
in response to determining that, for the current epoch, complete telemetry data from each of the plurality of cores has not been received, updating an epoch status in an epoch status indicator corresponding to the current epoch to indicate incomplete telemetry data.

37. The method of claim 36, wherein determining that, for the current epoch, complete telemetry data from each of the plurality of cores has not been received comprises:
generating a current epoch buffer window that includes the current epoch and extends beyond the current epoch and is within the current sampling time window; and
determining that complete telemetry data from the plurality of cores has not been received in the current epoch buffer window.

38. The method of claim 37, further comprising:
updating a write pointer to point to the buffer entry in the telemetry memory corresponding to the current epoch; and
determining that complete telemetry data from each of the plurality of cores has not been received in the current epoch, based on determining that the buffer entry corresponding to the write pointer does not have complete telemetry data from each of the plurality of cores.

39. The method of claim 38, further comprising:
in response to determining that complete telemetry data from each of the plurality of cores has not been received in the current epoch buffer window:
updating the write pointer to a next buffer entry in the telemetry memory for the current epoch.

40. The method of claim 36, further comprising:
in response to determining that, for the current epoch, complete telemetry data from each of the plurality of cores has not been received:
generating an interrupt indicating missing telemetry data for the current epoch; and
updating the epoch status in the epoch status indicator corresponding to the current epoch to indicate incomplete telemetry data.
